(19) United States
(12) Patent Application Publication
(10) Pub. No.: US 2017/0251240 A1
(43) Pub. Date: Aug. 31, 2017

(54) BULLET SCREEN INFORMATION PROCESSING METHOD, CLIENT, SERVICE PLATFORM AND STORAGE MEDIUM

(71) Applicant: TENCENT TECHNOLOGY (SHENZHEN) COMPANY LIMITED, Shenzhen (CN)

(72) Inventor: Ao Peng, Shenzhen (CN)

(21) Appl. No.: 15/597,639

(22) Filed: May 17, 2017

Related U.S. Application Data
(63) Continuation of application No. PCT/CN2015/096364, filed on Dec. 3, 2015.

(30) Foreign Application Priority Data
Jan. 20, 2015 (CN) 201510029072.3

(51) Int. Cl. H04N 21/431; H04N 21/475; H04N 21/472; H04N 21/25; H04N 21/44

(52) U.S. Cl. CPC H04N 21/4316; H04N 21/252; H04N 21/44012; H04N 21/47205; H04N 21/4756; H04N 21/65

(57) ABSTRACT

Disclosed is a bullet screen information processing method, a client and a service platform. In the method, bullet screen information sent by a service platform is received, the bullet screen information is formed on the basis of watching feedback information sent by a first client or a second client, and the watching feedback information is formed when a user watches first multimedia information; and the bullet screen information is dynamically displayed in a first output area in which the first client outputs the first multimedia information according to a predetermined strategy.

### CROSS-REFERENCE TO RELATED APPLICATIONS

This is a continuation application of International Patent Application No. PCT/CN2015/096364, filed on Dec. 3, 2015, which claims priority to Chinese Patent Application No. 201510029072.3 filed on Jan. 20, 2015, the disclosure of which is incorporated by reference herein in its entirety.

### TECHNICAL FIELD

The disclosure relates to the information technology, and more particularly to a bullet screen information processing method, a client, a service platform and a storage medium.

### BACKGROUND

Along with development of the electronic technology, electronic devices have been used more and more widely; and people gradually get used to watching multimedia information such as pictures or videos with their electronic devices. However, typically, a user may watch multimedia information presented at his/her electronic device, but when watching the multimedia information, the user cannot express his/her feelings about multimedia information or timely know feelings of other users who are also watching the multimedia information. That is, the electronic device may have the problem of not being intelligent enough to meet high-level demands of the user.

### SUMMARY

In view of the above, it is desired that embodiments of the disclosure provide a bullet screen information processing method, a client, a service platform and a storage medium, so as to improve resource utilization and intelligence of the client and the service platform.

A first aspect of the embodiment of the disclosure provides a bullet screen information processing method, which may include: receiving bullet screen information from a server, wherein the bullet screen information is formed on the basis of watching feedback information, and the watching feedback information is formed by at least one of the first electronic device and a second electronic device, in response to an input, during output of first multimedia information, and sent to the server; and dynamically displaying the bullet screen information in a first output area, in which the first electronic device outputs the first multimedia information, according to a predetermined strategy, wherein the bullet screen information is displayed as being overlaid on the first multimedia information.

A second aspect of the embodiment of the disclosure provides a bullet screen information processing method, which may include: receiving watching feedback information from at least one of a first electronic device and a second electronic device, wherein the watching feedback information is formed by the at least one of the first electronic device and the second electronic device, in response to an input, during output of first multimedia information; forming bullet screen information on the basis of the watching feedback information; and sending the bullet screen information to the first electronic device which is outputting or intended to output the first multimedia information, wherein the first electronic device dynamically displays the bullet screen information when outputting the first multimedia information, and the bullet screen information is displayed as being overlaid on the first multimedia information.

A third aspect of the embodiment of the disclosure provides a first electronic device, which may include: a processor; and a memory for storing instructions, which, when being executed by the processor, cause the processor to: receive bullet screen information from a server, wherein the bullet screen information is formed on the basis of watching feedback information, and the watching feedback information is formed by at least one of the first electronic device and a second electronic device, in response to an input, during output of first multimedia information, and sent to the server; and dynamically display the bullet screen information in a first output area, in which the first electronic device outputs the first multimedia information, according to a predetermined strategy, wherein the bullet screen information is displayed as being overlaid on the first multimedia information.

A fourth aspect of the embodiment of the disclosure provides a server, which may include: a processor; and a memory for storing instructions, which, when being executed by the processor, cause the processor to: receive watching feedback information from at least one of a first electronic device and a second electronic device, wherein the watching feedback information is formed by the at least one of the first electronic device and the second electronic device, in response to an input, during output of first multimedia information; form bullet screen information on the basis of the watching feedback information; and send the bullet screen information to the first electronic device which is outputting or intended to output the first multimedia information, wherein the first electronic device dynamically displays the bullet screen information when outputting the first multimedia information, and the bullet screen information is displayed as being overlaid on the first multimedia information.

The embodiment of the disclosure further provides a non-transitory computer storage medium, in which a computer-executable instruction is stored, the computer-executable instruction being configured to execute at least one of the abovementioned bullet screen information processing methods.

According to the bullet screen information processing method, client, service platform and storage medium of the embodiment of the disclosure, the bullet screen information overlaid on the first multimedia information and dynamically displayed may be formed on the basis of the watching feedback information of the user at the same time when the first multimedia information is displayed, so that the user may conveniently and favourably express he/her own watching feeling, the user may also conveniently watch the bullet screen information on the premise of not dragging a display page, software and hardware resources of the client and the service platform are better utilized, and intelligence and user satisfaction of the client and the service platform are improved.

### BRIEF DESCRIPTION OF THE DRAWINGS

FIG. 1 is a first flowchart of a bullet screen information processing method according to an embodiment of the disclosure;

FIG. 2 is a first effect diagram of a bullet screen information processing method according to an embodiment of the disclosure;

FIG. 3 is a second effect diagram of a bullet screen information processing method according to an embodiment of the disclosure;

FIG. 4 is a second flowchart of a bullet screen information processing method according to an embodiment of the disclosure;

FIG. 5 is a third effect diagram of a bullet screen information processing method according to an embodiment of the disclosure;

FIG. 6 is a fourth effect diagram of a bullet screen information processing method according to an embodiment of the disclosure;

FIG. 7 is a fifth effect diagram of a bullet screen information processing method according to an embodiment of the disclosure;

FIG. 8 is a third flowchart of a bullet screen information processing method according to an embodiment of the disclosure;

FIG. 9 is a sixth effect diagram of a bullet screen information processing method according to an embodiment of the disclosure;

FIG. 10 is a fourth flowchart of a bullet screen information processing method according to an embodiment of the disclosure;

FIG. 11 is a fifth flowchart of a bullet screen information processing method according to an embodiment of the disclosure;

FIG. 12 is a first structure diagram of a first client according to an embodiment of the disclosure;

FIG. 13 is a second structure diagram of a first client according to an embodiment of the disclosure;

FIG. 14 is a third structure diagram of a first client according to an embodiment of the disclosure;

FIG. 15 is a first structure diagram of a service platform according to an embodiment of the disclosure;

FIG. 16 is a second structure diagram of a service platform according to an embodiment of the disclosure; and

FIG. 17 is a third structure diagram of a service platform according to an embodiment of the disclosure.

### DETAILED DESCRIPTION

The subject matter of the disclosure will be further elaborated below with reference to the drawings and embodiments in detail, and it should be understood that the embodiments described below are only intended to describe and explain the disclosure and not intended to limit the disclosure.

In the context, the term “bullet screen”, also referred to as “bullet curtain” or “barrage”, does not refer to actual bullets, but may refer to, for example, text and/or picture messages that audience members send via their electronic devices, such as mobile terminals, while watching a video. The messages are then projected onto the screen, so that at any given time the scene may be overlaid with multiple “bullets,” or comments, scrolling across the screen.

### Embodiment 1

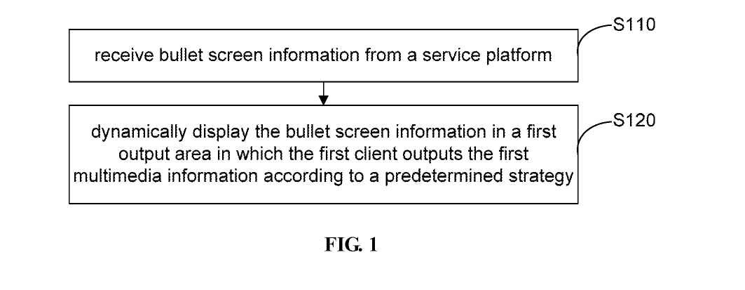

As shown in FIG. 1, the embodiment provides a bullet screen information processing method, which includes the following steps.

At Step 110, bullet screen information is received from a service platform. Here, the bullet screen information is a piece of to-be-displayed information formed on the basis of watching feedback information sent by a first client or a second client, and the watching feedback information is a piece of feedback information formed when a user watches first multimedia information.

At Step 120, the bullet screen information is dynamically displayed in a first output area in which the first client outputs the first multimedia information according to a predetermined strategy Here, the bullet screen information is displayed as being overlaid on the first multimedia information.

In the embodiment, the bullet screen information processing method is applied in the first client. The first client may include an electronic device, such as a mobile phone, a tablet computer, a notebook computer, a desktop computer or a projector, which is connectable to the service platform and may display multimedia information.

The first multimedia information is one of various pieces of multimedia information, and specifically, may be a piece of multimedia information, such as a picture or a video. When the multimedia information is a video, the video may be of any type, such as a teleplay, a movie, an animation, a variety show or a talk show.

In the embodiment, the first client, when displaying the first multimedia information according to an instruction of the user, may receive the bullet screen information generated on the basis of the first multimedia information. The bullet screen information is formed on the basis of user feedback information submitted by individual users watching the first multimedia information. The user feedback information includes information such as comments, feelings or ridicules of the users watching the multimedia information. The bullet screen information may directly include a content of the user feedback information. However, the bullet screen information is information which is set by the service platform to be dynamically displayed in the first client according to the predetermined strategy.

The bullet screen information may include text bullet screen information and picture bullet screen information. The text bullet screen information includes information in a text format; and the picture bullet screen information is bullet screen information including a picture. The bullet screen information including the picture may include a text and an image.

In Step 120, the bullet screen information may be displayed in the first output area in which the first multimedia information is output. Here, the first output area includes a display area of the first client.

Here, the operation that the bullet screen information is displayed as being overlaid on the first multimedia information may be implemented as follows: the first client displays the first multimedia information in a first layer of the first output area, and displays the bullet screen information in a second layer, where the second layer is above the first layer, so that the bullet screen information may generate a covering effect on the first multimedia information at its display position.

By such a method of displaying or outputting the first multimedia information and the bullet screen information in the same first output area, the user may conveniently watch the multimedia information and the bullet screen information at the same time.

The first output area of the bullet screen information is usually smaller than an area in which the first multimedia information is output; and in order to enable the user to conveniently distinguish the bullet screen information from caption information of the multimedia information, the bullet screen information may usually be output in an upper half 1/H of the first output area of the first multimedia information. H is a positive integer not smaller than 2; and specifically, for example, H may be a value such as 2, 3 or 5. Therefore, it may avoid interference of the bullet screen information to display of the caption information.

Regarding how to specifically dynamically display the bullet screen information according to the predetermined strategy in Step 120, the following two optional manners are provided.

Optional Manner 1:

Step 120 may include that: the bullet screen information is displayed, and the bullet screen information is controlled to move according to a predetermined trajectory.

Here, the predetermined trajectory may be located in the first output area in which the first client outputs the first multimedia information.

There may be one or more predetermined trajectories, specifically, for example, 1, 2, 3 or 5. Typically, multiple predetermined trajectories are arranged parallel to one another. One predetermined trajectory may be used to display multiple pieces of bullet screen information.

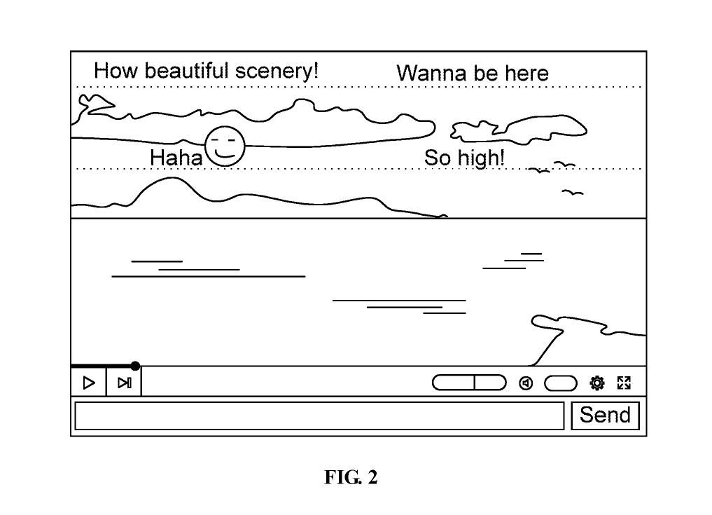

Specifically, as shown in FIG. 2, three invisible predetermined trajectories are formed at an upper half part of the first output area of the first multimedia information; and the predetermined trajectories are usually arranged parallel to a display direction of the cation information.

At least two pieces of bullet screen information are displayed on each predetermined trajectory, and specific display contents of the pieces of bullet screen information are usually different from one another.

Such a display method may be applied to display text bullet screen information and/or picture bullet screen information in the bullet screen information, and is particularly applicable to display of the text bullet screen information. When the text bullet screen information moves from left to right of a video according to the predetermined trajectory, such a manner is consistent with a reading habit of the user, thereby improving experiences of the user in reading the text bullet screen information.

As regards to whether the bullet screen information moves from left to right or moves from right to left according to the predetermined trajectory, it may be determined through setting information received from the user.

As shown in FIG. 2, an image frame in the first multimedia information is displayed in the first area, and the image frame is a scenery image; and four pieces of bullet screen information are displayed as being overlaid on the scenery image. Bullet screen contents of the four pieces of bullet screen information are respectively: How beautiful scenery! Wanna be here, So high! and Haha [symbol] . These pieces of bullet screen information move along the predetermined trajectory, specifically such as the predetermined trajectory shown as the dotted line in the figure. When the first client displays the multimedia information and the bullet screen information, the predetermined trajectory may not be displayed, so as to avoid influence on a watching effect of the first multimedia information.

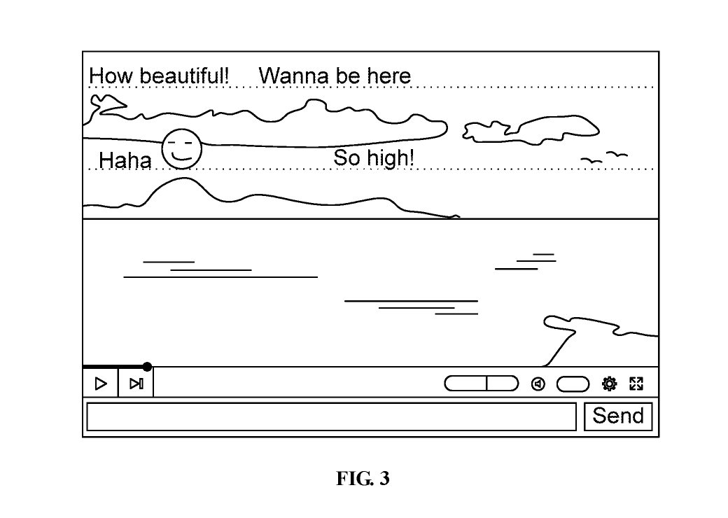

FIG. 3 is a display effect diagram of a display image of first multimedia information switched when bullet screen information moves along the predetermined trajectory. Obviously, along with movement of the bullet screen information, the bullet screen information “How beautiful scenery!” has partially moved out of the first display screen. Display positions of the other pieces of bullet screen information have also correspondingly been changed.

Optional Manner 2:

Step 120 may include that: the bullet screen information is displayed at a first position at an nth instant; and the bullet screen information is hidden at the first position at an (n+1)th instant, n being an integer not smaller than 1 and smaller than N, N being the total number of display times of the bullet screen information, and N being an integer not smaller than 2.

The (n+1)th instant is an instant later than the nth instant. The method of the embodiment may also be called a flickering display method for the bullet screen information. That is, the bullet screen information is displayed in a first period of time, and the bullet screen information is hidden in a second period of time; and the bullet screen information is repeatedly displayed and hidden for multiple times like this to implement dynamic display of the bullet screen information.

In a specific implementation process, the bullet screen information may be displayed at a fixed position in the first output area of the first multimedia information in a flickering manner, may also be displayed in the flickering manner along the predetermined trajectory in optional manner 1 and move along the predetermined trajectory at the same time. Specifically, for example, the bullet screen information is positioned on a left part of the predetermined trajectory when being displayed for the first time, is positioned at a middle position of the predetermined trajectory when being displayed for the second time and is positioned on a right part of the predetermined trajectory when being displayed for the third time. In this way, flickering display and predetermined-trajectory-based dynamic display are combined. Optional manner 2 may be used to display of the text bullet screen information and the picture bullet screen information, and is particularly suitable for dynamic display of the picture bullet screen information.

During specific implementation, a piece of bullet screen information may include both a text bullet screen information part and picture bullet screen information; and at this instant, a choice may be made according to a content of the bullet screen information. Specifically, for example, if the text bullet screen information is a main content of the bullet screen information or the text bullet screen information expresses a larger amount of information, optional manner 1 may be preferably adopted to display the bullet screen information.

The embodiment provides the bullet screen information processing method, which mainly includes that the bullet screen information is received from the service platform and the bullet screen information is displayed; and the bullet screen information is formed according to the watching feedback information which is formed by the client watching the first multimedia information according to a user input, so that the user may conveniently and timely send the watching feedback information to the service platform when watching the first multimedia information, and the service platform may form the bullet screen information formed by the client according to the watching feedback information sent according to a user instruction and overlap and display the bullet screen information over the first multimedia information for the user to view in real time.

In a specific implementation process, each piece of bullet screen information corresponds to a display time limit, which may be considered as a display life cycle of the bullet screen information; the display time limit determines a display time period of the bullet screen information; and the bullet screen information may not be displayed beyond the display time period. Here, the display time period corresponds to a time period in which the first multimedia information is output.

The display time limit may also be the number of times that is specified for each piece of bullet screen information to be displayed in the first output area of the first multimedia information, a display time interval between two adjacent displays is preset, and after each piece of bullet screen information is displayed in the first output area for the specified number of times, the bullet screen information becomes invalid and may not be displayed any longer.

Determination of the display time limit may be associated with time when the client forms the watching feedback information. Generally, the user may be inspired by a certain fragment or a certain scene when watching the first multimedia information, and then the watching feedback information may be formed. In order to enable other users to know the watching feeling of the user more accurately, the bullet screen information may usually be displayed in the corresponding fragment.

When the bullet screen information is dynamically displayed in optional manner 1, the number of times of movement of the bullet screen information along the predetermined trajectory may be limited, so as to implement control display of the bullet screen information; and when the bullet screen information is displayed in optional manner 2, its dynamic display may be controlled by using the number of display times as well as the display time period. In optional manner 2, a display time of a piece of bullet screen information is usually equal to a hiding time.

### Embodiment 2

As shown in FIG. 1, the embodiment provides a bullet screen information processing method, which includes the following steps.

At Step 110, bullet screen information is received from a service platform. Here, the bullet screen information is a piece of to-be-displayed information formed on the basis of watching feedback information sent by a first client or a second client, and the watching feedback information is a piece of feedback information formed when a user watches first multimedia information.

At Step 120, the bullet screen information is dynamically displayed in a first output area in which the first client outputs the first multimedia information according to a predetermined strategy Here, the bullet screen information is displayed as being overlaid on the first multimedia information.

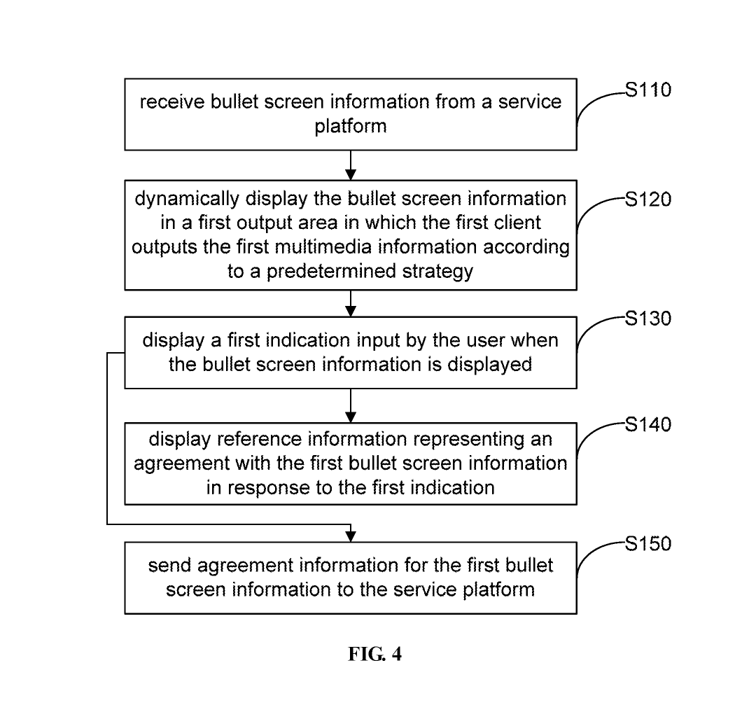

As shown in FIG. 4, the method further includes the following steps.

At Step 130, a first indication input by the user is received when the bullet screen information is displayed. Here, the first indication represents an agreement with first bullet screen information in the bullet screen information.

At Step 140, reference information representing the agreement with the first bullet screen information is displayed in response to the first indication.

At Step 150, agreement information for the first bullet screen information is sent to the service platform.

In the embodiment, the first client may not only dynamically display the bullet screen information but also interact with the bullet screen information according to the indication of the user.

Specifically, for example, when a piece of bullet screen information is displayed, the user may express his/her own comments, specifically such as an agreement after reading the bullet screen information; and in the embodiment, in order to facilitate interaction between the user and the bullet screen information, when the first client displays the bullet screen information, a human-computer interaction interface may also be enabled to receive the indication about the agreement with one or more pieces of bullet screen information from the user. In Step 130, the term “First” in the first bullet screen information has no special meaning, and is only used to denote one of the multiple pieces of bullet screen information.

Specifically, for example, the first client receives the first indication input by the user through a mouse or a touch screen or a floating touch screen. For example, the first indication may be a swipe of the mouse, a touch or a floating touch gesture. Whether the user input is the first indication or another indication input by the user may be determined by the first client according to a preset identification strategy. In the embodiment, the first indication represents that the user agrees with a content in the first bullet screen information.

In response to the first indication, the first client may further display the reference information representing the agreement with the first bullet screen information, to notify that the input first indication has been received and executed by the first client; and therefore, user satisfaction may be improved.

In order to facilitate the service platform to count the pieces of the agreement information representing the agreement with each piece of bullet screen information, in Step 150, the first client may further send the agreement information to the service platform; in such a manner, the user may interact with the first bullet screen information when watching the first multimedia information; and intelligence of the first client is greatly improved, information processing resources of an electronic device is better utilized, and the user satisfaction is improved.

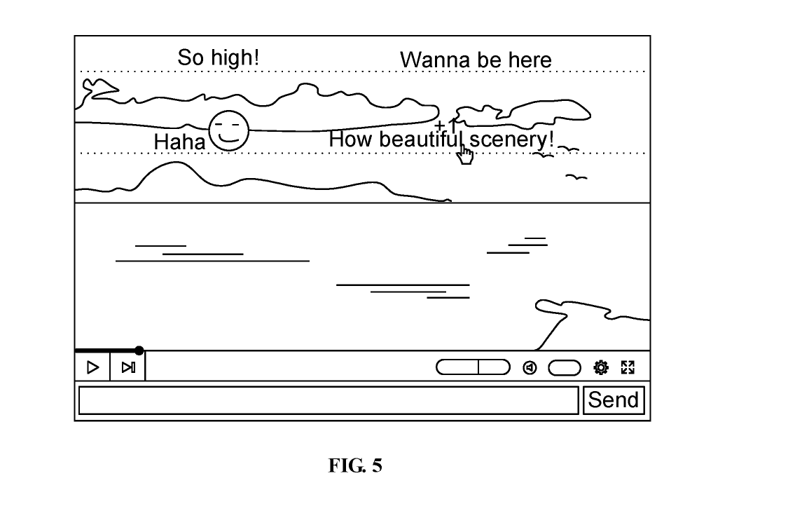

A hand-shaped icon shown in FIG. 5 represents a current indication icon of the mouse; and after the user inputs the first indication through the mouse, “+1” is displayed on the first client as the reference information representing the agreement, so that it is conveniently notified that the user currently agrees with the bullet screen information.

As a further improvement of the embodiment, it is supposed that m is the number of pieces of the agreement information obtained by the first bullet screen information within a first specified time period; and

Step 130 may include that: the first bullet screen information is displayed with a first display parameter when m is within a first specified range; or the first bullet screen information is displayed with a second display parameter when m is within a second specified range. Here, the first specified range is different from the second specified range, and the first display parameter is different from the second display parameter.

The first specified range and the second specified range usually correspond to two different numerical value ranges. For example, the first specified range may be larger than 50, and the second specified range may not be larger than 50.

Each of the first display parameter and the second display parameter may include a display colour of the bullet screen information, a display form of the bullet screen information, a display background colour of the bullet screen information and the like.

For example, when the first bullet screen information is text bullet screen information, with its specific content being: Chi Haidong is so talented; and when the number of pieces of agreement information obtained by the first bullet screen information is within the first specified range, for example, larger than 100, it is indicated that the bullet screen information is hot, a relatively warmer font colour may be adopted for display, for example, a red font may be adopted to display the text bullet screen information. When the number of pieces of the agreement information obtained by the first bullet screen information is within the second specified range, for example, no bullet screen information is obtained, the bullet screen information is obviously not so hot or not popular, a relatively cold font colour may be adopted to display the bullet screen information, for example, a white font may be adopted for display.

In a specific implementation process, the first display parameter and the second display parameter may include a size of fonts or pictures. The first display parameter and the second display parameter may further include a character pattern or the like display parameters.

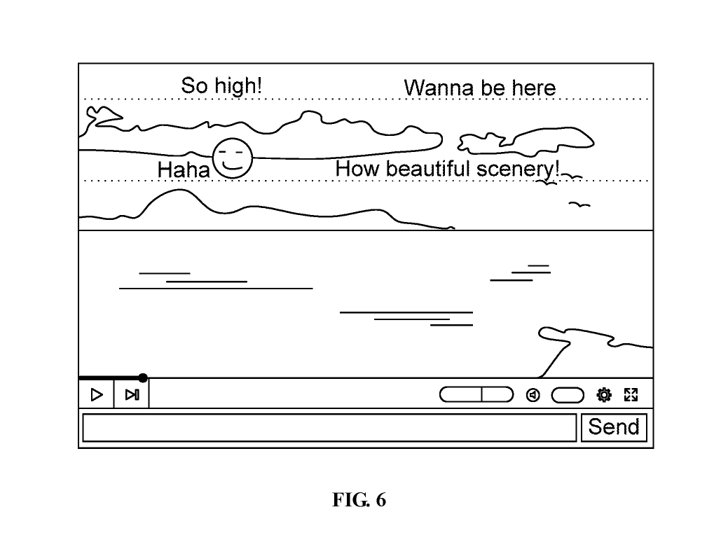

As shown in FIG. 6, when the bullet screen information “How beautiful scenery!” obtains more pieces of agreement information, it is apparently displayed to be larger than other bullet screen information, so as to be distinguished from the other bullet screen information obtaining less pieces of agreement information.

For example, when display colours are adopted for distinguishing, a piece of bullet screen information which obtains no agreement information is displayed in white; a piece of bullet screen information which obtains 1 to 9 pieces of agreement information may be displayed in light yellow; and a piece of bullet screen information which obtains 10 to 29 pieces of agreement information may be displayed in orange.

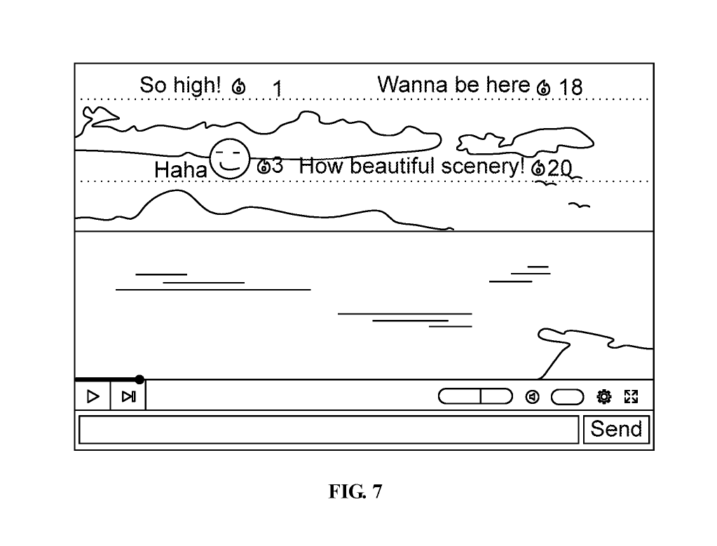

As shown in FIG. 7, the bullet screen information may include two parts: a first part is a bullet screen content; and the bullet screen content is formed according to the watching feedback information, and is usually the same as the watching feedback information. A second part may be information such as the number of pieces of agreement information obtained by the bullet screen content. The second part may specifically include an agreement icon and the number of pieces of the agreement information obtained in the vicinity of the agreement icon. In FIG. 7, the second part may include a flame shown as “ [symbol] ” and a digit besides the flame; and the digit may represent the number of pieces of the agreement information currently obtained by the bullet screen information.

In such a manner, when the first client outputs the bullet screen information, not only may the bullet screen content be output, but also the information such as the agreement information obtained by the bullet screen content may be output, so that the bullet screen content of the first bullet screen information output by the user or currently displayed on the first client and the agreement information of other users about the bullet screen information may be conveniently displayed.

Each piece of bullet screen information may correspond to an index; the agreement information may include an index of the bullet screen information to which it is directed and information representing agreement; and therefore, a server may subsequently know from the index the bullet screen information to which the agreement information is directed conveniently.

The first specified time may be a predetermined time period, and the first specified time may optionally be equal to the display time limit in method embodiment 1. That is, agreement information received when the first bullet screen information is invalid may all be considered as agreement information obtained within the first specified time.

### Embodiment 3

As shown in FIG. 1, the embodiment provides a bullet screen information processing method, which includes the following steps.

At Step 110, bullet screen information is received from a service platform. Here, the bullet screen information is a piece of to-be-displayed information formed on the basis of watching feedback information sent by a first client or a second client, and the watching feedback information is a piece of feedback information formed when a user watches first multimedia information.

At Step 120, the bullet screen information is dynamically displayed in a first output area in which the first client outputs the first multimedia information according to a predetermined strategy Here, the bullet screen information is displayed as being overlaid on the first multimedia information.

As shown in FIG. 4, the method further includes the following steps.

At Step 130, a first indication input by the user is received when the bullet screen information is displayed. Here, the first indication represents an agreement with first bullet screen information in the bullet screen information;

At Step 140, reference information representing the agreement with the first bullet screen information is displayed in response to the first indication; and

At Step 150, agreement information for the first bullet screen information is sent to the service platform.

In the embodiment, the first client may not only dynamically display the bullet screen information but also interact with the bullet screen information according to the indication of the user.

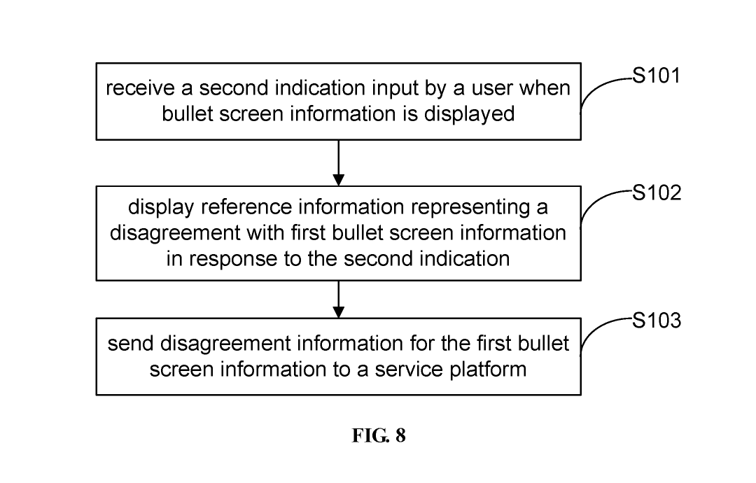

As shown in FIG. 8, the method further includes the following steps.

At Step 101, a second indication input by the user is received when the bullet screen information is displayed. Here, the second indication represents a disagreement with the first bullet screen information in the bullet screen information.

At Step 102, reference information representing the disagreement with the first bullet screen information is displayed in response to the second indication.

At Step 103, disagreement information for the first bullet screen information is sent to the service platform.

In the embodiment, the first client may further receive the second indication input by the user, and the second indication is used for the user to input his/her own feedback information when reading bullet screen information, with which the user disagrees, displayed in the first client.

Specifically, for example, when the first bullet screen information is: How poor performance of Kobe today, and a user disagrees, the second indication may be input to the first client, and the first client sends disagreement information representing disagreement to the service platform, so as to facilitate the service platform to set information such as a display parameter of the bullet screen information.

In combination with the bullet screen information processing method of the embodiment and the bullet screen information processing method of the previous embodiment, the user may conveniently give a thumb up to the bullet screen information the user agrees with, such that the first client sends the agreement information, and the user may also conveniently express disagreement with the bullet screen information the user disagrees with, such that the first client sends the disagreement information.

In view of this, m represents the number of pieces of the agreement information obtained by the first bullet screen information within a first specified time; n represents the number of pieces of the disagreement information obtained by the first bullet screen information within the first specified time; both m and n may be 0 or positive integers; s=m−n; n is an integer.

The step that the bullet screen information is dynamically displayed may include that: the first bullet screen information is displayed with a third display parameter when s is within a third specified range; or the first bullet screen information is displayed with a fourth display parameter when s is within a fourth specified range. The third specified range is different from the fourth specified range. The third display parameter is different from the fourth display parameter.

The disagreement information may also include a content such as an index of the bullet screen information to which it is directed and the disagreement information, so that the service platform may subsequently count the pieces of the disagreement information obtained by each piece of bullet screen information conveniently.

The third display parameter may be the same as or different from the first display parameter or the second display parameter; and the fourth display parameter may also be the same as or different from the first display parameter or the second display parameter.

Each of the first display parameter to the fourth display parameter may represent a display colour, background colour, font, form, size and display effect parameter of the bullet screen information. The display effect parameter specifically, for example, is an effect of an underlined font or a bold font.

In the embodiment, the display parameter of the bullet screen information is determined by combining the numbers of pieces of the agreement information and disagreement information obtained by the same bullet screen information. Specifically, for example, according to the technical solution of method embodiment 2, when both bullet screen information A and bullet screen information B obtain 200 pieces of agreement information, bullet screen information A and bullet screen information B have the same display parameter. However, in the present embodiment, the number of pieces of the obtained disagreement information is also to be considered. Specifically, for example, if bullet screen information A obtains 10 pieces of disagreement information and bullet screen information B obtains 205 pieces of disagreement information, it is apparently indicated that most of the users agree with a bullet screen content of bullet screen information A, while bullet screen information B is a piece of controversial bullet screen information, and its bullet screen content is a controversial and topical bullet screen content. At this instant, in order to distinguish the two pieces of bullet screen information, the two pieces of bullet screen information are displayed with different display parameters for the user to conveniently distinguish.

### Embodiment 4

As shown in FIG. 1, the embodiment provides a bullet screen information processing method, which includes the following steps.

At Step 110, bullet screen information is received from a service platform. Here, the bullet screen information is a piece of to-be-displayed information formed on the basis of watching feedback information sent by a first client or a second client, and the watching feedback information is a piece of feedback information formed when a user watches first multimedia information.

At Step 120, the bullet screen information is dynamically displayed in a first output area in which the first client outputs the first multimedia information according to a predetermined strategy Here, the bullet screen information is displayed as being overlaid on the first multimedia information.

As shown in FIG. 4, the method further includes the following steps.

At Step 130, a first indication input by the user is received when the bullet screen information is displayed. Here, the first indication represents an agreement with first bullet screen information in the bullet screen information.

At Step 140, reference information representing the agreement with the first bullet screen information is displayed in response to the first indication.

At Step 150, agreement information for the first bullet screen information is sent to the service platform.

In the embodiment, the first client may not only dynamically display the bullet screen information but also interact with the bullet screen information according to the indication of the user.

The dynamically displayed bullet screen information includes second bullet screen information formed on the basis of a user indication of a first account of the first client.

The method further includes that: feedback notification information sent by the service platform is received when agreement information of the second bullet screen information reaches a preset condition; and the feedback notification information is displayed in an interface of the first account in the first client.

Apparently, when the user of the first client is watching the first multimedia information, the watching feedback information may be sent to the service platform through the first client; and the watching feedback information may be presented in the first output area of the first multimedia information as bullet screen information.

At this instant, the service platform may perform information processing on the agreement information obtained by the second bullet screen information, specifically, such as operations of counting the pieces of the agreement information or disagreement information obtained by the second bullet screen information; and the service platform may further generate the feedback notification information according to an operating result of the agreement information or disagreement information obtained by the second bullet screen information, and send it to the first client.

The determining that the agreement information of the second bullet screen information reaches the preset condition may be performed in one of at least the following two manners.

Manner 1: the number M of pieces of the agreement information obtained by the second bullet screen information reaches a specified value. At this instant, the feedback notification information may include information such as the number of pieces of the agreement information obtained by the second bullet screen information or a sequencing result of the agreement information obtained by the second bullet screen information. Specifically, M is the number of pieces of the agreement information obtained within a first specified time.

Manner 2: the preset condition is: determining whether the second bullet screen information obtains any agreement information or not, and when the second bullet screen information obtains the agreement information, considering the preset condition is met, and sending the feedback notification information to the first account of the first client. As shown in FIG. 7, the feedback notification information may include: Melissa has just given a thump up to your comment. Here, the comment is a kind of watching feedback information. Melissa is an account name of a second account; and at this instant, the first account may determine the account which currently agrees with the watching feedback information input by the first account through the watching feedback information. When manner 2 is adopted, single push service may be set in the service platform; and after the second bullet screen information obtains a piece of agreement information, the single push service may send the feedback notification information to the first client of the first account in real time. In such a manner, the first client may timely acquire feedback information of bullet screen information sent by another client, it is unnecessary for the first client to actively request to acquire the information, and apparently, sending the feedback notification information in a push manner by adopting the single push service may facilitate timely notifying the user of the feedback notification information and fulfilling the aim of more timely message transmission.

For either of the manners, output of the watching feedback information of the first multimedia information through the bullet screen information and interaction between different users are well implemented, software and hardware resources of the first client and the service platform are better utilized, intelligence of the client and the service platform are obviously improved, and meanwhile, user satisfaction is improved.

During specific implementation, the feedback notification information may further include a preset incentive strategy and incentive information formed for the second specified information; and the incentive information includes information on incentive assigned to the first account.

When the first multimedia information is watched, a service provider or an output party encourages the user to assess the first multimedia information, and also encourages feedback to the bullet screen information; for this, a certain incentive may be provided. Specifically, for example, incentive credits are provided for the user; and thereafter, the user may exchange multimedia information, such as a pay movie or teleplay, he/she desires to watch, with the credits.

From the above, the embodiment further provides a bullet screen information-based interaction method on the basis of method embodiment 2 to method embodiment 4. According to this embodiment, the client and the service platform are better utilized, and the intelligence and user satisfaction of the client and the service platform are improved.

### Embodiment 5

As shown in FIG. 1, the embodiment provides a bullet screen information processing method, which includes the following steps.

At Step 110, bullet screen information is received from a service platform. Here, the bullet screen information is a piece of to-be-displayed information formed on the basis of watching feedback information sent by a first client or a second client, and the watching feedback information is a piece of feedback information formed when a user watches first multimedia information.

At Step 120, the bullet screen information is dynamically displayed in a first output area in which the first client outputs the first multimedia information according to a predetermined strategy Here, the bullet screen information is displayed as being overlaid on the first multimedia information.

As shown in FIG. 4, the method further includes the following steps.

At Step 130, a first indication input by the user is received when the bullet screen information is displayed. Here, the first indication represents an agreement with first bullet screen information in the bullet screen information.

At Step 140, reference information representing the agreement with the first bullet screen information is displayed in response to the first indication.

At Step 150, agreement information for the first bullet screen information is sent to the service platform.

The method further includes that: an interaction position at which user input is received is detected in the first output area; and the first bullet screen information is statically displayed when a distance between the interaction position and the first bullet screen information is within a specified range of a first specified distance. Here, the specified range is used to receive the first indication or second indication input by the user.

When the distance between the interaction position and the first bullet screen information is within the first specified range, it may be considered that the user is intended to input an indication to the first bullet screen information; and in order to facilitate operation, the first bullet screen information is stopped to be dynamically displayed, and instead, the bullet screen information is statically displayed, for facilitating bullet screen information-based interaction of the user.

The interaction position may specifically be a position of an indication icon formed in the first output area by an electronic device, such as a wired mouse, a wireless mouse or a remote controller, which establishes a data connection with the first client.

Specifically, for example, when the indication icon of the mouse floats over one of multiple pieces of bullet screen information, this piece of bullet screen information is stopped to be dynamically displayed, and is statically displayed instead. A position of a hand-shaped icon shown in FIG. 5 is the interaction position.

Whether the first client receives the first indication or the second indication may be determined according to a received operating parameter, specifically, such as the number of clicking times of the mouse. For example, when single-click operation over the mouse is received, it may be considered that the user inputs the first indication; and if double-click operation over the mouse is received, it may be considered as the user inputs the second indication.

For another example, whether the user inputs the first indication or the second indication is determined according to the interaction position. For example, when the interaction position is below the first bullet screen information, it is indicated that the user is intended to vote up the bullet screen information, and it may be considered that the user inputs the first indication; and when the interaction position is above the first bullet screen information, it is indicated that the user is intended to vote down the bullet screen information, and it may be considered that the user inputs the second indication.

Specifically, for example, when the first client includes a touch screen, whether the user inputs the first indication or the second indication may be determined according to the number of touch points. Specifically, if two touch points are detected, it may be considered that the user inputs the first indication; and if only one touch point is detected, it may be considered that the user inputs the second indication.

### Embodiment 6

As shown in FIG. 1, the embodiment provides a bullet screen information processing method, which includes the following steps.

At Step 110, bullet screen information is received from a service platform. Here, the bullet screen information is a piece of to-be-displayed information formed on the basis of watching feedback information sent by a first client or a second client, and the watching feedback information is a piece of feedback information formed when a user watches first multimedia information.

At Step 120, the bullet screen information is dynamically displayed in a first output area in which the first client outputs the first multimedia information according to a predetermined strategy Here, the bullet screen information is displayed as being overlaid on the first multimedia information.

As shown in FIG. 4, the method further includes the following steps.

At Step 130, a first indication input by the user is received when the bullet screen information is displayed. Here, the first indication represents an agreement with first bullet screen information in the bullet screen information.

At Step 140, reference information representing the agreement with the first bullet screen information is displayed in response to the first indication.

At Step 150, agreement information for the first bullet screen information is sent to the service platform.

At Step 101, a second indication input by the user is received when the bullet screen information is displayed. Here, the second indication represents a disagreement with the first bullet screen information in the bullet screen information.

At Step 102, reference information representing the disagreement with the first bullet screen information is displayed in response to the second indication.

At Step 103, disagreement information for the first bullet screen information is sent to the service platform.

The method further includes that: sequencing information sent by the service platform is received, the sequencing information including information on all of part of a sequencing result formed by sequencing m or s of the first multimedia information by the service platform; and the sequencing information is displayed in a second output area, the second output area being an output area positioned near the first output area.

The first client includes an output area; the output area may be divided into the first output area and the second output area; the first output area is an area in which the first multimedia information is output, and specifically, for example, is an output area in which each image frame of the first multimedia information is output; and the second output area is an output area positioned near the first output area, and specifically, for example, is positioned on the right hand of the first output area, below the first output area, or the like.

10 pieces of bullet screen information for which the numbers of pieces of agreement information are ranked to be top 10 are determined according to m; and 10 pieces of bullet screen information which are the most controversial are selected according to s. When the number of pieces of the bullet screen information of the first multimedia information is smaller than 10, the sequencing information may include all the sequencing result information; and when there are more than 10 pieces of bullet screen information, the sequencing information may be part of the sequencing result information.

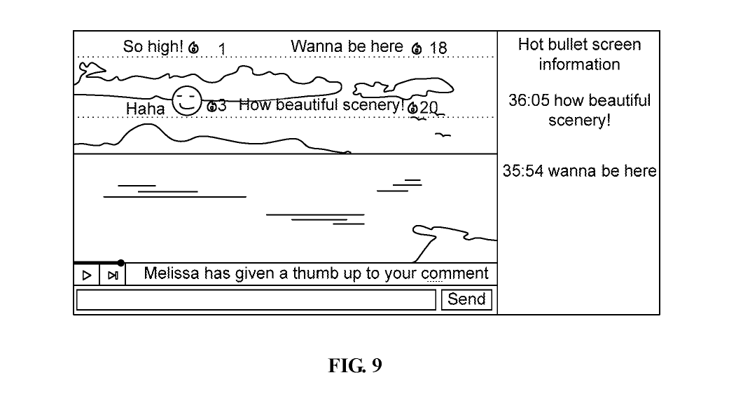

As shown in FIG. 9, several pieces of hot bullet screen information: “How beautiful scenery! “and “Wanna be here” are displayed in the second output area on the right hand of the first output area. Time 36:05 and 35:54 positioned in front of the bullet screen information are both forming time for forming the watching feedback information of the bullet screen information.

In FIG. 9, the bullet screen information may include a bullet screen content and information associated with the agreement information or the disagreement information.

Apparently, in such a manner, the user may conveniently view the currently hottest or most controversial bullet screen information and the like. Regarding how to specifically sequence or regarding meanings represented by sequencing results, it may be set according to a sequencing rule, and the service platform performs sequencing by executing codes according to the sequencing rule.

### Embodiment 7

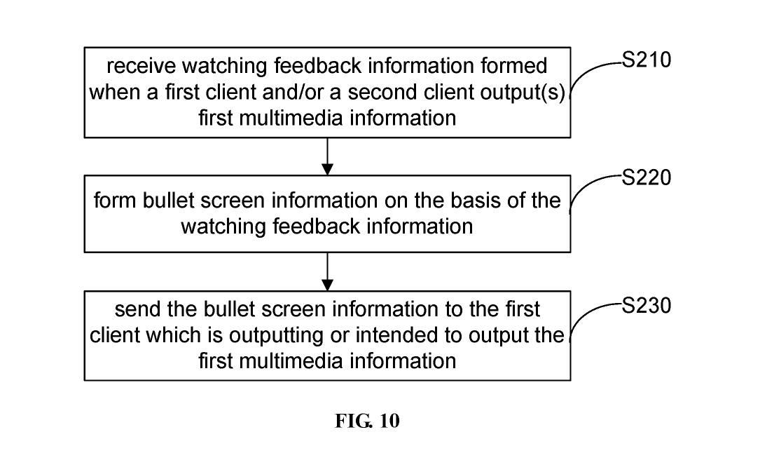

As shown in FIG. 10, the embodiment provides a bullet screen information processing method, which includes the following steps.

At Step 210, watching feedback information formed when a first client and/or a second client output(s) first multimedia information is received, wherein the watching feedback information is feedback information formed when a user watches the first multimedia information;

At Step 220, bullet screen information is formed on the basis of the watching feedback information; and

At Step 230, the bullet screen information is sent to the first client which is outputting or intended to output the first multimedia information.

Here, the bullet screen information is dynamically displayed by the first client when outputting the first multimedia information, and the bullet screen information is displayed as being overlaid on the first multimedia information.

The bullet screen information processing method of the embodiment is applied to a service platform; the service platform is a service equipment positioned on a service side, and may specifically an information provision service platform which provides the first multimedia information, or a service platform connected with the first multimedia information provision service platform.

The service platform may receive the watching feedback information sent by the first client and the second client; the watching feedback information may usually be assessment information input by the user; and the watching feedback information may include information such as a text, a picture and an emoticon.

In the embodiment, the service platform converts the watching feedback information into the bullet screen information in Step 120. The operation that the bullet screen information is formed according to the watching feedback information in Step 120 may include that: the watching feedback information is audited, some specified information being filtered through the auditing, specifically such as information involving personal defamation, attacks or illegal propagation or virus information which may cause an information security problem. Display of such information on the client as bullet screen information may cause negative influence or dissatisfaction of the user.

The watching feedback information passing the auditing is converted into bullet screen information which may be displayed in an area in which the first client outputs the multimedia information. Step 120 may include that a display parameter of the bullet screen information is set, and may further include that an information amount of each piece of bullet screen information is adjusted. Specifically, if the watching feedback information sent by the user includes a picture of which a data volume is S1, since an information amount of the picture is excessive, the information amount of the bullet screen information may be sharply increased; and since the bullet screen information generally has a small size, data volume compression processing may be performed on the picture to reduce the data volume and the like.

The formed bullet screen information is sent to the first client which is outputting or intended to output the first multimedia information, so as to facilitate the first client to output the bullet screen information at the same time of outputting the first multimedia information. In such a manner, the user may express his/her own watching feeling information about the first multimedia information at the same time of watching the first multimedia information and submit it to the service platform in form of watching feedback information, and the service platform displays the watching feeling information in an output area of the first multimedia information in form of bullet screen information. At the same time, the user may further read bullet screen information formed on the basis of watching feedback information of another user at the same time of watching the first multimedia information. The bullet screen information is displayed as being overlaid on the first multimedia information, particularly different from the related art in which the watching feedback information of the user is positioned in another output area outside the output area of the first multimedia information, and in such a manner, the user may conveniently and synchronously read the bullet screen information without moving a display page at the same time of watching the first multimedia information, intelligence of an electronic device such as the service platform and the client is improved, software and hardware resources of the client and the service platform are better utilized, and user satisfaction is improved.

During implementation, descriptions related to the first multimedia information and the bullet screen information may refer to any of the abovementioned method embodiments, and will not be repeated herein.

### Embodiment 8

As shown in FIG. 10, the embodiment provides a bullet screen information processing method, which includes the following steps.

At Step 210, watching feedback information formed when a first client and/or a second client output(s) first multimedia information is received, wherein the watching feedback information is feedback information formed when a user watches the first multimedia information;

At Step 220, bullet screen information is formed on the basis of the watching feedback information; and

At Step 230, the bullet screen information is sent to the first client which is outputting or intended to output the first multimedia information.

Here, the bullet screen information is dynamically displayed by the first client when outputting the first multimedia information, and the bullet screen information is displayed as being overlaid on the first multimedia information.

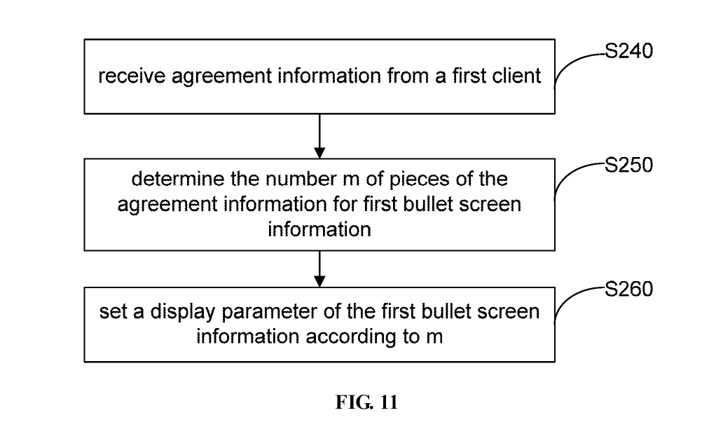

As shown in FIG. 11, the method further includes the following steps.

At Step 240, agreement information sent by the first client is received. Here, the agreement information is information formed and sent by the first client on the basis of a first indication input by the user and the first indication represents an agreement with first bullet screen information in the bullet screen information;

At Step 250, the number m of pieces of the agreement information for the first bullet screen information is determined; and

At Step 260, a display parameter of the first bullet screen information is set according to m.

In the embodiment, the agreement information sent by the first client is further received; and the agreement information represents the agreement with a certain piece of bullet screen information according to an indication of the user.

In the embodiment, a display parameter for subsequent display of the bullet screen information is set according to the agreement information obtained by each piece of bullet screen information. Specifically, for example, after the bullet screen information is displayed for a thousand times along with the first multimedia information, the bullet screen information obtains many pieces of agreement information, it is indicated that the bullet screen information is bullet screen information users quite agree with, and in order to highlight the first bullet screen information, its corresponding display parameter is distinguished from other bullet screen information the user does not so agree with, to fulfil the aim of enabling the first client to highlight the first bullet screen information.

Based on the method of the embodiment, when the bullet screen information is played, a display colour of the first bullet screen information is green during previous display, while the display colour of the first bullet screen information may be changed into red during next display, and this is because the service platform resets the display parameter of the first bullet screen information according to the number m of pieces of the agreement information.

The following optional manner is provided, without limitation, for specifically how to set the display parameter of the bullet screen information.

Step 260 may include that: the display parameter of the first bullet screen information is configured to be a first display parameter when m is within a first specified range; or the display parameter of the first bullet screen information is configured to be a second display parameter when m is within a second specified range.

Here, the first specified range is different from the second specified range, and the first display parameter is different from the second display parameter.

The display parameter of the first bullet screen information is determined according to a value of m. The display parameter may include a display parameter such as a display colour, a display font, a display form, a display size, a movement velocity on the predetermined trajectory in the abovementioned method embodiment and a display and hiding time period during flickering display.

Values and definitions of the first specified range and the second specified range may refer to corresponding parts in the abovementioned method embodiment, and will not be repeated herein.

The bullet screen information processing method of the embodiment mainly describes how the service platform sets the display parameter of the bullet screen information, so as to facilitate the first client to display the bullet screen information according to the display parameter and to implement control over display of the bullet screen information, so as to control display effects of the bullet screen information with different pieces of agreement information by the display parameters, to notify the user of a popularity or agreement degree of different bullet screen information. The popularity degree of different bullet screen information is transmitted by adopting different display parameters, and is not notified to the user directly by adopting information such as a text, so that the advantages of simplifying display of the information and reducing a displayed information amount are achieved.

### Embodiment 9

As shown in FIG. 10, the embodiment provides a bullet screen information processing method, which includes the following steps.

At Step 210, watching feedback information formed when a first client and/or a second client output(s) first multimedia information is received, wherein the watching feedback information is feedback information formed when a user watches the first multimedia information;

At Step 220, bullet screen information is formed on the basis of the watching feedback information; and

At Step 230, the bullet screen information is sent to the first client which is outputting or intended to output the first multimedia information.

Here, the bullet screen information is dynamically displayed by the first client when outputting the first multimedia information, and the bullet screen information is displayed as being overlaid on the first multimedia information.

As shown in FIG. 11, the method further includes the following steps.

At Step 240, agreement information sent by the first client is received. Here, the agreement information is information formed and sent by the first client on the basis of a first indication input by the user and the first indication represents an agreement with first bullet screen information in the bullet screen information;

At Step 250, the number m of pieces of the agreement information for the first bullet screen information is determined; and

At Step 260, a display parameter of the first bullet screen information is set according to m.

In the embodiment, the agreement information sent by the first client is further received; and the agreement information represents the agreement with a certain piece of bullet screen information according to an indication of the user.

The method further includes the following steps.

At Step 270, disagreement information sent by the first client is received. Here, the disagreement information is formed and sent by the first client on the basis of a second indication input by the user and the second indication represents a disagreement with the first bullet screen information in the bullet screen information;

At Step 280, the number n of pieces of the disagreement information obtained by the first bullet screen information is determined.

Here, the step that the display parameter of the first bullet screen information is set according to m includes that: the display parameter of the first bullet screen information is set according to m and n.

In the embodiment, there is no specific requirement on executing sequence of Step 270 and 280 and Step 240 to 260. Step 270 and Step 280 may be executed after Step 240 to Step 260, and may also be executed before Step 240 to Step 260.

In the embodiment, both the number of pieces of the agreement information for the first bullet screen information and the number of pieces of the disagreement information for the first bullet screen information are determined, so that different opinions of users may be obtained; and when the display parameter of the first bullet screen information is set, both the agreement information and disagreement information for the first bullet screen information are taken in account. In this way, the user, after reading the bullet screen content of the bullet screen information, does not have to send a piece of information to express his/her disagreement with a bullet screen content of bullet screen information, and instead, may directly disagree, so that an information amount of the watching feedback information stored in the service platform may be reduced, and the user's operation of opposing a certain piece of bullet screen information is simplified.

As a further improvement of the embodiment, the following optional manner is provided, without limitation, for specifically how to set the display parameter of the bullet screen information according to m and n.

The step that the display parameter of the first bullet screen information is set according to m and n includes that: s is calculated according to a function relationship s=m−n;

the display parameter of the first bullet screen information is set to be a third display parameter when s is within a third specified range; or the display parameter of the first bullet screen information is set to be a fourth display parameter when s is within a fourth specified range.

The third specified range is different from the fourth specified range. The third display parameter is different from the fourth display parameter.

In the embodiment, descriptions related to the third specified range, the fourth specified range, the third display parameter and the fourth display parameter may refer to the abovementioned method embodiment, and will not be repeated herein.

The embodiment not only provides a method for setting the display parameter of the bullet screen information according to the agreement information and the disagreement information, but also provides how to specifically set the display parameter of the bullet screen information according to the agreement information and the disagreement information, and thus has the advantage of being easy for implementation.

### Embodiment 10

As shown in FIG. 10, the embodiment provides a bullet screen information processing method, which includes the following steps.

At Step 210, watching feedback information formed when a first client and/or a second client output(s) first multimedia information is received, wherein the watching feedback information is feedback information formed when a user watches the first multimedia information;

At Step 220, bullet screen information is formed on the basis of the watching feedback information; and

At Step 230, the bullet screen information is sent to the first client which is outputting or intended to output the first multimedia information.

Here, the bullet screen information is dynamically displayed by the first client when outputting the first multimedia information, and the bullet screen information is displayed as being overlaid on the first multimedia information.

As shown in FIG. 11, the method further includes the following steps.

At Step 240, agreement information sent by the first client is received. Here, the agreement information is information formed and sent by the first client on the basis of a first indication input by the user and the first indication represents an agreement with first bullet screen information in the bullet screen information;

At Step 250, the number m of pieces of the agreement information for the first bullet screen information is determined; and

At Step 260, a display parameter of the first bullet screen information is set according to m.

The bullet screen information sent to the first client includes second bullet screen information formed on the basis of a user indication of a first account of the first client.

The method further includes that: feedback notification information is sent to the first client when agreement information for the second bullet screen information reaches a preset condition; and the feedback notification information is displayed in an interface of the first account in the first client.

Reaching the preset condition may include that a specified number M of pieces of agreement information are obtained by the second bullet screen information; or the preset condition may be, for example, the second bullet screen information obtains agreement information.

Specifically, for example, when the number M of pieces of the agreement information obtained by the second bullet screen information reaches a first specified value, the feedback notification information is sent to the first client; and the feedback notification information is displayed by the first client in the interface of the first account. The feedback notification information includes the number M of pieces of the agreement information obtained by the second bullet screen information within the first specified time. In such a manner, the user of the first account of the first client may timely acquire how many pieces of agreement information is obtained by the bullet screen information formed according to his/her own watching feedback information, i.e., how many other users support himself/herself.

For another example, when the second bullet screen information obtains a piece of agreement information, the service platform correspondingly forms a piece of feedback notification information, and the feedback notification information sent to the first account of the first client may include information such as an account identifier of a second account sending the agreement information to the second bullet screen information. In such a manner, the user of the first account of the first client may timely know whether the bullet screen information formed according to his/her own watching feedback information obtains an agreement of any other user as well as know the users who agree.

In any embodiment of the disclosure, an account (the account is a user account, specifically such as a QQLive account) may send only one piece of agreement information or disagreement information for a piece of bullet screen information; or the same account may agree or disagree with a piece of bullet screen information for many times, but considered as just once. Therefore, the problem that the user repeatedly gives thumbs up to or repeatedly disagrees with the same bullet screen information may be solved. For how to specifically limit multiple agreements or multiple disagreements of an account with the same bullet screen information, identification information of a user account forming agreement information or disagreement information is acquired at the same time when the agreement information or the disagreement information is formed, and statistics is made according to the identification information.

As a further improvement to the embodiment, the method may further include that: incentive information is formed according to the agreement information of the second bullet screen information and a preset incentive strategy. Here, the incentive information is used to form the feedback notification information.

Specifically, for example, when the specified number of pieces of agreement information are obtained by the second bullet screen information, some incentives may be provided for an account providing watching feedback information for the second bullet screen information according to the preset incentive strategy, such as comment credits, account level credits or rights of watching specified multimedia information, and the incentive information is formed according to the provided incentives, and is sent to the client in the feedback notification information for the user to acquire; in such a manner, more users may be inspired to participate in provision of watching feedback information and participate in bullet screen information-based interaction, so that activeness of the user may be improved; and therefore, the client and the service platform may be better utilized for communication between users and between the users and a multimedia information provider, the service platform may conveniently determine multimedia information popular with most of the users and hobby features of single users according to the watching feedback information of the users and the bullet screen information-based interaction; further, the multimedia information may be selectively loaded on the service platform according to the hobbies of most of the users, multimedia information of which single users may be fond may be recommended to the users according to the hobby features of the users, and the intelligence of the service platform and user satisfaction may be improved.

### Embodiment 11

As shown in FIG. 10, the embodiment provides a bullet screen information processing method, which includes the following steps.

At Step 210, watching feedback information formed when a first client and/or a second client output(s) first multimedia information is received, wherein the watching feedback information is feedback information formed when a user watches the first multimedia information;

At Step 220, bullet screen information is formed on the basis of the watching feedback information; and

At Step 230, the bullet screen information is sent to the first client which is outputting or intended to output the first multimedia information.

Here, the bullet screen information is dynamically displayed by the first client when outputting the first multimedia information, and the bullet screen information is displayed as being overlaid on the first multimedia information.

As shown in FIG. 11, the method further includes the following steps.

At Step 240, agreement information sent by the first client is received. Here, the agreement information is information formed and sent by the first client on the basis of a first indication input by the user and the first indication represents an agreement with first bullet screen information in the bullet screen information;

At Step 250, the number m of pieces of the agreement information for the first bullet screen information is determined; and

At Step 260, a display parameter of the first bullet screen information is set according to m.

In the embodiment, the agreement information sent by the first client is further received; and the agreement information represents the agreement with a certain piece of bullet screen information according to an indication of the user.

The method further includes the following steps.

At Step 270, disagreement information sent by the first client is received. Here, the disagreement information is formed and sent by the first client on the basis of a second indication input by the user and the second indication represents a disagreement with the first bullet screen information in the bullet screen information;

At Step 280, the number n of pieces of the disagreement information obtained by the first bullet screen information is determined.

The step that the display parameter of the first bullet screen information is set according to m includes that: the display parameter of the first bullet screen information is set according to m and n. The method further includes that: sequencing is performed according to m and s, to form sequencing result information; and all or part of the sequencing result information is sent to the first client. The sequencing result information is displayed by the first client in a second output area; and the second output area is an output area positioned near the first output area.

Therefore, the user may conveniently acquire the bullet screen information with which most of users currently agree or the bullet screen information which is most controversial or with which most of the users disagree in the second output area of the first client, software and hardware resources of the service platform and the client are better utilized, and intelligence of the service platform and the client is improved.

### Embodiment 12

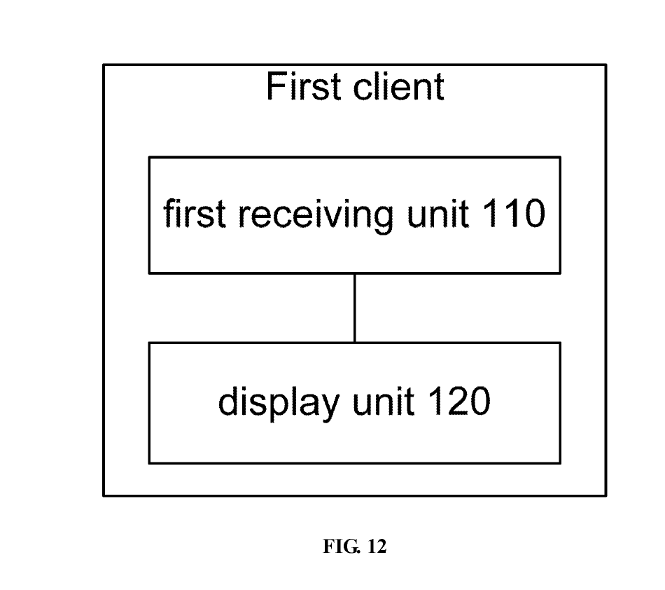

As shown in FIG. 12, the embodiment provides a client, which is the first client.

The first client includes a first receiving unit 110 and a display unit 210.

The first receiving unit 110 is configured to receive bullet screen information from a service platform. The bullet screen information is information to be displayed formed on the basis of watching feedback information sent by the first client and/or a second client, and the watching feedback information is feedback information formed when a user watches first multimedia information.

The display unit 120 is configured to dynamically display the bullet screen information in a first output area in which the first client outputs the first multimedia information according to a predetermined strategy, wherein the bullet screen information is displayed as being overlaid on the first multimedia information.

The first receiving unit 110 may include a receiving interface, the receiving interface may include a wired receiving interface and a wireless receiving interface; the wired interface may include an optical cable interface and a cable interface; and the wireless receiving interface may include a receiving antenna, such as a Wireless Fidelity (WiFi) antenna.

The display unit 120 may include various types of display screens, specifically such as a liquid crystal display screen, an Organic Light-Emitting Diode (OLED) display screen, an electronic ink display screen or a projection screen. The display unit 120 outputting the first multimedia information and the bullet screen information refers to outputting the first multimedia information and the bullet screen information in all or part of a display area of the display unit. The first output area is all of the display area or part of the display area of the display unit, and the first output area is used to output the first multimedia information and at least overlap and display the bullet screen information over the first multimedia information.

The first client is an electronic device which may be connectable to the service platform, and may usually be an electronic device which may form a network connection with the service platform through the Internet, such as a desktop computer, a notebook computer, a smart phone or a tablet computer.

The watching feedback information of the user may include information such as assessment information formed through the first client when the user watches the first multimedia information. The bullet screen information is information formed after the watching feedback information is processed by the service platform, and a bullet screen content of the bullet screen information usually includes an information content of the watching feedback information. Specific introductions about the watching feedback information and the bullet screen information may further refer to the method embodiments, and will not be repeated herein.

The embodiment provides the client, which may be configured for the user to watch the first multimedia information and may also be configured to enable the user, when watching the first multimedia information, to synchronously read the bullet screen information formed on the basis of watching feedback information of other users in the output area in which the first multimedia information is output.

The display unit 120 may be configured to display the bullet screen information and control the bullet screen information to move along a predetermined trajectory, which is positioned in the first output area in which the first client outputs the first multimedia information.

The display unit 120 may further be configured to display the bullet screen information at a first position at an nth instant and hide the bullet screen information at the first position at an (n+1)th instant; n is an integer not smaller than 1 and smaller than N; N is the total number of display times of the bullet screen information; and N is an integer not smaller than 2. At this time, the display unit 120 displays the bullet screen information in a flickering manner.

The bullet screen information includes text bullet screen information and picture bullet screen information; and the display unit 120 may usually display the text bullet screen information according to the predetermined trajectory, and may display the picture bullet screen information in the flickering manner.

During specific implementation, the display unit 120 may display the bullet screen information by combining the predetermined trajectory and the flickering display manner.

During specific implementation, the first client further includes an interaction unit; and the interaction unit may be configured to receive input of the user to form the watching feedback information, and send the watching feedback information to the service platform to form the bullet screen information. The interaction unit may specifically be various types of interaction interfaces, specifically such as a mouse, a keyboard, a remote controller, a touch screen or a voice interactor.

### Embodiment 13

As shown in FIG. 12, the embodiment provides a client, which is the first client.

The first client includes a first receiving unit 110 and a display unit 120.

The first receiving unit 110 is configured to receive bullet screen information from a service platform. Here, the bullet screen information is information to be displayed formed on the basis of watching feedback information sent by the first client or a second client, and the watching feedback information is feedback information formed when a user watches first multimedia information.

The display unit 120 is configured to dynamically display the bullet screen information in a first output area in which the first client outputs the first multimedia information according to a predetermined strategy, wherein the bullet screen information is displayed as being overlaid on the first multimedia information.

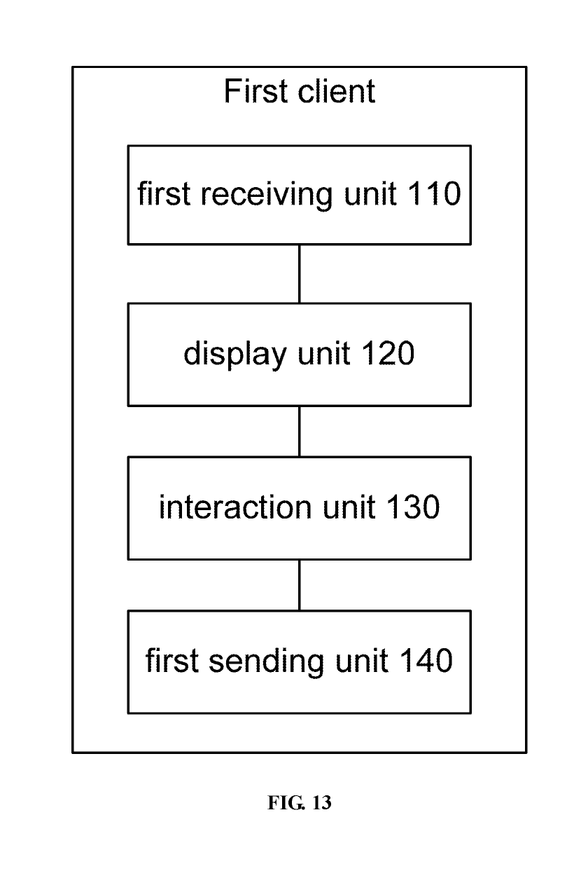

As shown in FIG. 13, the first client further includes an interaction unit 130 and a first sending unit 140.

The interaction unit 130 is configured to receive a first indication input by the user when the bullet screen information is displayed. The first indication represents an agreement with first bullet screen information in the bullet screen information.

The display unit 120 is configured to display reference information representing the agreement with the first bullet screen information in response to the first indication.

The first sending unit 140 is configured to send agreement information for the first bullet screen information to the service platform.

The specific structure of the interaction unit 130 may include various types of human-computer interaction interfaces, specifically such as a wired or wireless mouse, remote controller, touch screen, floating touch screen or voice input interface connected to the first client. The interaction unit 130 may further be configured to receive an assessment input by the user after watching the first multimedia information to form the watching feedback information.

The specific structure of the first sending unit 140 may include a sending interface; the sending interface may specifically include a wired interface and a wireless interface; the wired interface may include a cable interface or an optical cable interface; and the wireless interface may include a receiving antenna. In a specific implementation process, the first receiving unit 110 and the first sending unit 140 may integrally correspond to a communication interface with both receiving and sending functions.

In the embodiment, formation of the agreement information and the reference information may refer to corresponding descriptions about the corresponding method embodiment, and will not be further described herein in detail.

The first client of the embodiment further includes the interaction unit and the first sending unit on the basis of the previous embodiment, so that the user is enabled to perform information interaction with the displayed bullet screen information at the same time of watching the first multimedia information, software and hardware resources of the first client are better utilized, and intelligence of the client and user satisfaction are further improved.

### Embodiment 14

As shown in FIG. 12, the embodiment provides a client, which is the first client.

The first receiving unit 110 is configured to receive bullet screen information from a service platform. Here, the bullet screen information is information to be displayed formed on the basis of watching feedback information sent by the first client or a second client, and the watching feedback information is feedback information formed when a user watches first multimedia information.

The display unit 120 is configured to dynamically display the bullet screen information in a first output area in which the first client outputs the first multimedia information according to a predetermined strategy, wherein the bullet screen information is displayed as being overlaid on the first multimedia information.

The first client further includes an interaction unit 130 and a first sending unit 140.

The interaction unit 130 is configured to receive a first indication input by the user when the bullet screen information is displayed. The first indication represents an agreement with first bullet screen information in the bullet screen information.

The display unit 120 is configured to display reference information representing the agreement with the first bullet screen information in response to the first indication.

The first sending unit 140 is configured to send agreement information for the first bullet screen information to the service platform.

m is the number of pieces of the agreement information obtained by the first bullet screen information within a first specified time.

The display unit 120 is configured to display the first bullet screen information with a first display parameter when m is within a first specified range, or display the first bullet screen information with a second display parameter when m is within a second specified range.

Here, the first specified range is different from the second specified range, and the first display parameter is different from the second display parameter.

The display unit of the embodiment displays the first bullet screen information with different display parameters according to different numbers of pieces of agreement information obtained by the first bullet screen information. Specifically, for example, when the number of pieces of agreement information obtained by the first bullet screen information exceeds 100, it is considered that the number of pieces of the agreement information is within the first specified range, and the first bullet screen information is displayed with the first display parameter; and when the number of pieces of the agreement information obtained by the first bullet screen information is smaller than 100, it is considered that the number of pieces of the agreement information is within the second specified range, and the first bullet screen information is displayed with the second display parameter.

The first display parameter may include various display parameters such as a display colour, a background colour, brightness, a form, a font type, a display time or a display size. In the embodiment, the display unit 120 is specifically configured to implement display with different display parameters according to the number of pieces of agreement information obtained by each piece of bullet screen information, so as to distinguish the pieces of bullet screen information obtaining different numbers of pieces of agreement information, enable the user to directly know the piece of bullet screen information with which most of users agree currently by watching display effects of the pieces of bullet screen information and further improve intelligence of the client.

In addition, the first receiving unit 110 is further configured to receive sequencing information from the service platform; and the sequencing information is all or part of sequencing result information formed by performing sequencing on m or s of the first multimedia information. The display unit 120 is configured to display the sequencing information in a second output area. The second output area is an output area positioned near the first output area. Distribution of the first output area and the second output area may refer to, but not limited to, FIG. 9.

### Embodiment 15

As shown in FIG. 12, the embodiment provides a client, which is the first client.

The first receiving unit 110 is configured to receive bullet screen information from a service platform. Here, the bullet screen information is information to be displayed formed on the basis of watching feedback information sent by the first client or a second client, and the watching feedback information is feedback information formed when a user watches first multimedia information.

The display unit 120 is configured to dynamically display the bullet screen information in a first output area in which the first client outputs the first multimedia information according to a predetermined strategy, wherein the bullet screen information is displayed as being overlaid on the first multimedia information.

The first client further includes an interaction unit 130 and a first sending unit 140.

The interaction unit 130 is configured to receive a first indication input by the user when the bullet screen information is displayed. The first indication represents an agreement with first bullet screen information in the bullet screen information.

The display unit 120 is configured to display reference information representing the agreement with the first bullet screen information in response to the first indication.

The first sending unit 140 is configured to send agreement information for the first bullet screen information to the service platform.

m is the number of pieces of the agreement information obtained by the first bullet screen information within a first specified time.

The display unit 120 is configured to display the first bullet screen information with a first display parameter when m is within a first specified range, or display the first bullet screen information with a second display parameter when m is within a second specified range.

Here, the first specified range is different from the second specified range, and the first display parameter is different from the second display parameter.

The interaction unit 130 is further configured to receive a second indication input by the user when the bullet screen information is displayed. The second indication represents a disagreement with the first bullet screen information in the bullet screen information.

The display unit 120 is further configured to display reference information representing the disagreement with the first bullet screen information in response to the second indication.

The first sending unit 140 is further configured to send disagreement information for the first bullet screen information to the service platform.

In the embodiment, the interaction unit 130 may further be configured to receive the second indication; and a specific structure of the second indication and the area of the first indication may refer to the abovementioned method embodiment, and will not be repeated herein.

A specific structure of the interaction unit 130 may include various types of human-computer interaction interfaces mentioned above.

The reference information, representing the disagreement, displayed by the display unit 120 is significantly different from the reference information representing the disagreement in the previous embodiment, and specifically may be represented by, for example, different icons.

The specific structure of the first sending unit 140 may include various types of sending interfaces, not only may be configured to send the agreement information, but also may be send the disagreement information, so that software and hardware resources of the client are obviously better utilized, and intelligence of the client and user satisfaction are improved.

The client of the embodiment may allow the user not only to agree with the bullet screen information displayed on the client but also to disagree; and when the user disagrees with a bullet screen content of a certain piece of bullet screen information, it is unnecessary to actively send a piece of watching feedback information with a negative information content to the service platform for the service platform to form bullet screen information, and instead, the user may directly disagree, so that operation of the user is greatly simplified, and meanwhile, information processing and response time delay of the client and the service platform are simplified.

Of course, the client of the embodiment may be configured to provide specific implementation hardware for the bullet screen information processing method of method embodiment 3, and has the advantages of simple structure, high intelligence and the like.

As a further improvement to the embodiment, m represents the number of pieces of the agreement information obtained by the first bullet screen information within the first specified time; n represents the number of pieces of the disagreement information obtained by the first bullet screen information within the first specified time; both m and n are 0 or positive integers; s=m−n; n is an integer.

The display unit 120 may be specifically configured to display the first bullet screen information with a third display parameter when s is within a third specified range, or display the first bullet screen information with a fourth display parameter when s is within a fourth specified range,

Here, the third specified range is different from the fourth specified range, and the third display parameter is different from the fourth display parameter.

In the embodiment, on the basis of the previous embodiment, the display unit 120 implements discriminately display with different display parameters with reference to the number of pieces of the agreement information obtained by the bullet screen information as well as the number of pieces of the disagreement information obtained by the bullet screen information, so as to implement discriminately display of the pieces of bullet screen information obtaining different number of pieces of agreement information and/or disagreement information when displaying the bullet screen information, so that the user may conveniently and directly know whether a certain piece of bullet screen information is bullet screen information with which relatively more users agree or relatively more controversial bullet screen information according to a pre-known display rule and a display effect achieved by the display parameters.

In the embodiment, the display unit of the first client may achieve different display effects of the bullet screen information with different display parameters according to the agreement information obtained by the bullet screen information, and may also determine the display parameters and display effects of the bullet screen information according to different numbers of pieces of the agreement information and disagreement information obtained by the bullet screen information.

### Embodiment 16

As shown in FIG. 12, the embodiment provides a client, which is the first client.

The first receiving unit 110 is configured to receive bullet screen information from a service platform. Here, the bullet screen information is information to be displayed formed on the basis of watching feedback information sent by the first client or a second client, and the watching feedback information is feedback information formed when a user watches first multimedia information.

The display unit 120 is configured to dynamically display the bullet screen information in a first output area in which the first client outputs the first multimedia information according to a predetermined strategy, wherein the bullet screen information is displayed as being overlaid on the first multimedia information.

The first client further includes an interaction unit 130 and a first sending unit 140.

The interaction unit 130 is configured to receive a first indication input by the user when the bullet screen information is displayed. The first indication represents an agreement with first bullet screen information in the bullet screen information.

The display unit 120 is configured to display reference information representing the agreement with the first bullet screen information in response to the first indication.

The first sending unit 140 is configured to send agreement information for the first bullet screen information to the service platform.

The dynamically displayed bullet screen information includes second bullet screen information formed on the basis of a user indication of a first account of the first client.

The first receiving unit 110 is further configured to receive feedback notification information from the service platform when agreement information of the second bullet screen information reaches a preset condition.

The display unit 120 is further configured to display the feedback notification information in an interface of the first account in the first client.

Structures of the first receiving unit 110 and the display unit 120 may refer to the abovementioned equipment embodiment, and will not be repeated herein.

The first receiving unit 110 may specifically be configured to receive the feedback notification information from the service platform when the number M of pieces of agreement information obtained by the second bullet screen information reaches a first specified value; and specifically, for example, when the number M of pieces of the agreement information of the second bullet screen information reaches the first specified value, the service platform may actively send information to the first client, and at this instant, the first receiving unit 110 of the first client may receive the feedback notification information. The feedback notification information may specifically include the number M of pieces of the agreement information obtained by the second bullet screen information within the first specified time.

The display unit 120 may further be configured to display the feedback notification information in the interface of the first account in the first client.

In addition, the first receiving unit 110 may further be configured to receive the feedback notification information when the second bullet screen information obtains the agreement information. At this time, the service platform forms and notifies feedback notification information to the first client when detecting that another client agrees with the bullet screen information formed on the basis of the watching feedback information submitted by the first client and sends agreement information; and then, the first receiving unit 110 is configured to obtain the feedback notification information once the second bullet screen information obtains the agreement information. At this time, the feedback notification information may include information such as a second account which agrees with the second bullet screen information. Therefore, the subsequent communication and information interaction between the first account and the second account are facilitated.

In the embodiment, the first client may not only display the bullet screen information at the same time of displaying the first multimedia information, but also allow the user to perform bullet screen information-based interaction and obtain the feedback notification information formed by the agreement information for the bullet information formed on the basis of the watching feedback information.

### Embodiment 17

As shown in FIG. 12, the embodiment provides a client, which is the first client.

The first client includes a first receiving unit 110 and a display unit 120.

The first receiving unit 110 is configured to receive bullet screen information from a service platform. Here, the bullet screen information is information to be displayed formed on the basis of watching feedback information sent by the first client or a second client, and the watching feedback information is feedback information formed when a user watches first multimedia information.

The display unit 120 is configured to dynamically display the bullet screen information in a first output area in which the first client outputs the first multimedia information according to a predetermined strategy, wherein the bullet screen information is displayed as being overlaid on the first multimedia information.

As shown in FIG. 13, the first client further includes an interaction unit 130 and a first sending unit 140.

The interaction unit 130 is configured to receive a first indication input by the user when the bullet screen information is displayed. The first indication represents an agreement with first bullet screen information in the bullet screen information.

The display unit 120 is configured to display reference information representing the agreement with the first bullet screen information in response to the first indication.

The first sending unit 140 is configured to send agreement information for the first bullet screen information to the service platform.

The interaction unit 130 is further configured to receive a second indication input by the user when the bullet screen information is displayed. The second indication represents a disagreement with the first bullet screen information in the bullet screen information.

The display unit 120 is further configured to display reference information representing the disagreement with the first bullet screen information in response to the second indication.

The first sending unit 140 is further configured to send disagreement information for the first bullet screen information to the service platform.

The interaction 130 is configured to detect an interaction position in which user input is received in the first output area.

The display unit 120 is configured to statically display the first bullet screen information when a distance between the interaction position and the first bullet screen information is within a specified range of a first specified distance.

Here, the specified range is used to receive the first indication or second indication input by the user.

In the embodiment, the detection of the interaction position may be performed in various ways, which depend on a structure of the interaction unit 130. Specifically, for example, when the interaction unit includes a touch screen, the interaction position may include a touch position on the touch screen; and when the interaction unit includes a wired or wireless mouse or remote controller, the interaction position may be a position at which a display icon of the mouse or the remote controller on the display unit is located.

Specific structures of the interaction unit 130 and the display unit 120 may refer to the abovementioned embodiments, and will not be repeated herein. The display unit 120 dynamically displays the first bullet screen information, but since the distance between the interaction position detected by the interaction unit 130 and the first bullet screen information is within the specified range of the first specified distance, the display unit 120 is further configured to change a first bullet screen display mode and switch a dynamic mode of dynamically displaying the first bullet screen information into a static mode of statically displaying the first bullet screen information. In the static mode, the display unit may keep stably displaying the first bullet screen information before the interaction position moves out of the specified range; and at this time, the first bullet screen information may not move according to the predetermined trajectory, or may not be displayed in a flickering manner of alternate display and hiding.

Therefore, interaction between users is facilitated. Specifically, input of the first indication or the second indication is performed through control of an operating parameter such as single-click or double-click and the like.

The client of the embodiment has the advantages of high intelligence and high user satisfaction.

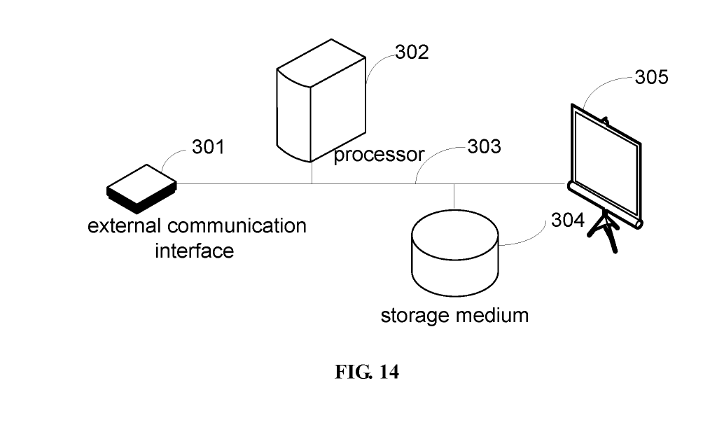

FIG. 14 shows a specific hardware structure of a first client according to an embodiment of the disclosure, and the client may be configured to implement any technical solution in the method embodiments of the disclosure, and includes a processor 302, a display 305, a storage medium 304 and at least one external communication interface 301; and the processor 302, the display 305, the storage medium 304 and the external communication interface 301 are all connected through a bus 303. The processor 302 may be an electronic device with a processing function such as an Application Processor (AP), a microprocessor, a Central Processing Unit (CPU), a Digital Signal Processor (DSP) or a Programmable Logic Controller (PLC). The storage medium 304 stores computer-executable instructions; and the processor 304 executes the computer-executable instruction stored in the storage medium 304 to execute the technical solutions in the embodiment of the disclosure, specifically such as the solution shown in FIG. 1 or FIG. 4.

The external communication interface 301 corresponds to the first sending unit and/or the first receiving unit. The display 305 may be a part of the display unit.

### Embodiment 18

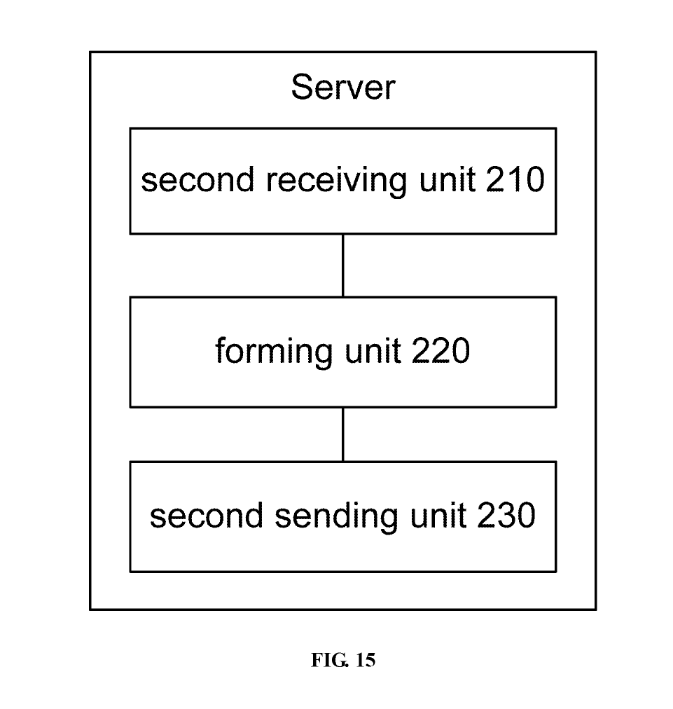

As shown in FIG. 15, the embodiment provides a service platform, which includes a second receiving unit 210, a forming unit 220 and a second sending unit 230.

The second receiving unit 210 is configured to receive watching feedback information formed when a first client and/or a second client output(s) first multimedia information. The watching feedback information may be feedback information formed when a user watches the first multimedia information.

The forming unit 220 is configured to form bullet screen information on the basis of the watching feedback information.

The second sending unit 230 is configured to send the bullet screen information to the first client which is outputting or intended to output the first multimedia information.

The bullet screen information is dynamically displayed by the first client when outputting the first multimedia information, and the bullet screen information is displayed as being overlaid on the first multimedia information.

The service platform of the embodiment may include one or more servers connected to each other, and specifically, the server may be a server which provides the first multimedia information or a server which is connected with the service platform providing the first multimedia information.

The second receiving unit 210 may include a receiving interface; the receiving interface may be a wired interface and a wireless interface; the wired interface may be a cable interface, and may also be an optical cable interface; and the wireless interface may include a structure such as a receiving antenna.

A specific structure of the forming unit 220 may include a processor and a storage medium; and the processor is connected with the storage medium through an internal communication interface such as a bus. The storage medium stores executable codes; and the processor reads and runs the executable code, and may implement a function of the forming unit 220. The processor may have a specific structure such as an AP, a CPU, a DSP and a PLC.

The second sending unit 230 may include a receiving interface, and the receiving interface may include a wired receiving interface and a wireless receiving interface; the wired interface may include an optical cable interface and a cable interface; and the wireless receiving interface may include a receiving antenna and the like.

During specific implementation, the second receiving unit 210 and the second sending unit 230 may integrally correspond to a communication interface with both receiving and sending functions, specifically such as an antenna with the receiving and sending functions or an Internet wired interface.

The service platform of the embodiment may specifically correspond to a hardware equipment entity, and may also correspond to a service platform formed by communication connections of multiple pieces of hardware equipment; and the service platform of the embodiment may be configured to provide implementation hardware for the bullet screen information processing method in method embodiment 7, and may be configured to implement any technical solution in method embodiment 7. Descriptions related to the bullet screen information and the watching feedback information may refer to embodiment 7 or method embodiment 1, and will not be repeated herein.

### Embodiment 19

As shown in FIG. 15, the embodiment provides a service platform, which includes a second receiving unit 210, a forming unit 220 and a second sending unit 230.

The second receiving unit 210 is configured to receive watching feedback information formed when a first client and/or a second client output(s) first multimedia information. The watching feedback information may be feedback information formed when a user watches the first multimedia information.

The forming unit 220 is configured to form bullet screen information on the basis of the watching feedback information.

The second sending unit 230 is configured to send the bullet screen information to the first client which is outputting or intended to output the first multimedia information.

The bullet screen information is dynamically displayed by the first client when outputting the first multimedia information, and the bullet screen information is displayed as being overlaid on the first multimedia information.

The second receiving unit 210 is further configured to receive agreement information from the first client. The agreement information is information formed and sent by the first client on the basis of a first indication input by the user, and the first indication represents an agreement with first bullet screen information in the bullet screen information; and

The service platform further includes a statistical unit and a setting unit.

The statistical unit is configured to determine the number m of pieces of the agreement information for the first bullet screen information.

The setting unit is configured to set a display parameter of the first bullet screen information according to m.

Specific structure of the statistical unit and the setting unit may also include one or more processors; the processors may execute executable codes to implement functions of the statistical unit and the setting unit respectively. The forming unit, the statistical unit and the setting unit may independently correspond to different processors, or may integrally correspond to a same processor. When at least two of the forming unit, the statistical unit and the setting unit integrally correspond to a same processor, the processor implements functions of different units by running time division or concurrent threads respectively.

The statistical unit and the setting unit may further correspond to different pieces of server equipment, and at this time, servers corresponding to the statistical unit and the setting unit establish a connection for information interaction.

The specific structure of the statistical unit may also have a structure such as a counter or a processor with a counting function.

According to the service platform of the embodiment, the statistical unit and the setting unit are formed to discriminately set display parameters for different pieces of bullet screen information according to the agreement information obtained by the first bullet screen information, so that the piece of bullet screen information obtaining more agreement information or less agreement information may be conveniently and discriminately displayed with different display effects in the first client subsequently; and therefore, the user may conveniently obtain watching feedback information of most of the other users, the service platform and the client are better utilized, and user satisfaction is improved.

As a further detailed description about the embodiment, the setting unit is configured to configure the display parameter of the first bullet screen information to be a first display parameter when m is within a first specified range, or configure the display parameter of the first bullet screen information to be a second display parameter when m is within a second specified range. The first specified range is different from the second specified range; and the first display parameter is different from the second display parameter.

The first specified range and the second specified range may be determined according to an average number of pieces of the agreement information obtained by each piece of bullet screen information of the first multimedia information in advance, or may be dynamically determined according to a sequence of the numbers of pieces of the agreement information obtained by the pieces of bullet screen information of the first multimedia information.

In a word, the setting unit of the embodiment sets the display parameter for the first bullet screen information according to the number m of pieces of the agreement information. The display parameter includes the first display parameter and the second display parameter, such as a display colour, a display background colour, a display form, a display size and a display time length; and generally, the first display parameter and the second display parameter may achieve different display effects on the bullet screen information, so that the user may conveniently know the bullet screen information with which most of the users agree according to the display effects of the bullet screen information.

In a specific implementation process, the bullet screen information may include parts such as a bullet screen content and an identification content of agreement information related information. The bullet screen content may be determined according to the watching feedback information, and the identification content is formed by information such as the numbers of pieces of the agreement information obtained by the bullet screen information or the sequences of the numbers of pieces of the agreement information; in such a manner, the user may know whether the bullet screen information obtains agreements of most of the users or not by reading the information such as the identification content in the bullet screen information; and therefore, information acquisition of the user may also be facilitated.

### Embodiment 20

As shown in FIG. 15, the embodiment provides a service platform, which includes a second receiving unit 210, a forming unit 220 and a second sending unit 230.

The second receiving unit 210 is configured to receive watching feedback information formed when a first client and/or a second client output(s) first multimedia information. The watching feedback information may be feedback information formed when a user watches the first multimedia information.

The forming unit 220 is configured to form bullet screen information on the basis of the watching feedback information.

The second sending unit 230 is configured to send the bullet screen information to the first client which is outputting or intended to output the first multimedia information.

The bullet screen information is dynamically displayed by the first client when outputting the first multimedia information, and the bullet screen information is displayed as being overlaid on the first multimedia information.

The second receiving unit 210 is further configured to receive agreement information from the first client. The agreement information is information formed and sent by the first client on the basis of a first indication input by the user and the first indication represents an agreement with first bullet screen information in the bullet screen information.

The service platform further includes a statistical unit and a setting unit.

The statistical unit is configured to determine the number m of pieces of the agreement information of the first bullet screen information.

The setting unit is configured to set a display parameter of the first bullet screen information according to m.

The second receiving unit 210 is further configured to receive disagreement information from the first client. The disagreement information is information formed and sent by the first client on the basis of a second indication input by the user and the second indication represents a disagreement with the first bullet screen information in the bullet screen information.

The statistical unit is further configured to determine the number n of pieces of the disagreement information obtained by the first bullet screen information.

The setting unit is configured to set the display parameter of the first bullet screen information according to m and n.

Structures of the second receiving unit 210, the statistical unit and the setting unit may refer to the previous embodiment, and will not be elaborated herein. The second receiving unit in the embodiment may not only receive the agreement information for the bullet screen information from the first client and/or the second client, but also receive the disagreement information for the first bullet screen information; and the disagreement information represents the disagreement with a bullet screen content of the first bullet screen information.

The display parameter of the bullet screen information may further be set according to the disagreement information obtained by the bullet screen information when being set, so that the user may directly determine whether the bullet screen information is controversial bullet screen information or bullet information obtaining more agreements or bullet screen information obtaining more disagreements according to a display effect of the bullet screen information; and software and hardware resources of the service platform are better utilized, intelligence of the service platform and the client is improved, and a requirement of interaction of the user with the bullet screen information may be met.

The setting unit is configured to calculate s according to a function s=m-n; set the display parameter of the first bullet screen information to be a third display parameter when s is within a third specified range; or set the display parameter of the first bullet screen information to be a fourth display parameter when s is within a fourth specified range. The third specified range is different from the fourth specified range, and the third display parameter is different from the fourth display parameter.

In the embodiment, the service platform is defined not only to set the display parameter of the bullet screen information according to the disagreement information for the bullet screen information, but also how to specifically set the display parameter according to the function between the agreement information and the disagreement information, and thus the embodiment has the advantage of being easy for implementation.

Formation of the disagreement information may refer to the corresponding description in the method embodiment, and will not be further repeated herein.

In the embodiment, the display parameter of the bullet screen information is determined according to the function s=m−n. During specific implementation, a correction result of s may also be obtained by correction with a correction factor. The correction factor may be a correction factor representative of a disagreement degree of the disagreement information, and may further include a correction factor representative of an agreement degree of the agreement information; and the correction factor may be a product factor or weighting factor.

Specifically, for example, the user executes double-click operation on a disagreement area within a specified range of the bullet screen information through a mouse to vote down the bullet screen information twice to form a higher degree disagreement, and an accordingly formed disagreement factor may be multiplied by a product factor larger than 1. If the user executes single-click operation on the disagreement area within the specified range of the bullet screen information through the mouse to vote down the bullet screen information once to form a lower degree disagreement, and the accordingly formed disagreement factor is 1.

From the above, the setting unit may set the display parameter of the bullet screen information according to the agreement information and disagreement information for the bullet screen information, so that the first client may discriminately display the pieces of bullet screen information obtaining different numbers of pieces of agreement information and/or disagreement information subsequently.

In addition, the forming unit may further be configured to perform sequencing according to m or s to form sequencing result information; the second sending unit may further be configured to send all or part of the sequencing result information to the first client; the sequencing result information is displayed by the first client in a second output area; and the second output area is an output area positioned near the first output area.

Therefore, the user may conveniently view currently the hottest bullet screen information, the most controversial bullet screen information or the like through the first client.

### Embodiment 21

As shown in FIG. 15, the embodiment provides a service platform, which includes a second receiving unit 210, a forming unit 220 and a second sending unit 230.

The second receiving unit 210 is configured to receive watching feedback information formed when a first client and/or a second client output(s) first multimedia information. The watching feedback information may be feedback information formed when a user watches the first multimedia information.

The forming unit 220 is configured to form bullet screen information on the basis of the watching feedback information.

The second sending unit 230 is configured to send the bullet screen information to the first client which is outputting or intended to output the first multimedia information.

The bullet screen information is dynamically displayed by the first client when outputting the first multimedia information, and the bullet screen information is displayed as being overlaid on the first multimedia information.

The second receiving unit 210 is further configured to receive agreement information from the first client. The agreement information is information formed and sent by the first client on the basis of a first indication input by the user, and the first indication represents an agreement with first bullet screen information in the bullet screen information; and

The service platform further includes a statistical unit and a setting unit.

The statistical unit is configured to determine the number m of pieces of the agreement information for the first bullet screen information.

The setting unit is configured to set a display parameter of the first bullet screen information according to m.

The bullet screen information sent to the first client includes second bullet screen information formed on the basis of a user indication of a first account of the first client.

The second sending unit 230 is further configured to send feedback notification information to the first client when agreement information for the second bullet screen information reaches a preset condition.

The feedback notification information is displayed by the first client in an interface of the first account.

Specifically, for example, the second sending unit 230 is configured to send the feedback notification information to the first client when the number M of pieces of the agreement information obtained by the second bullet screen information reaches a first specified value; and the feedback notification information is displayed by the first client in the interface of the first account. Here, the feedback notification information includes the number M of pieces of the agreement information obtained by the second bullet screen information within the first specified time. At this time, the preset condition is that the number M of pieces of the agreement information obtained by the second bullet screen information reaches the first specified value.

For another example, the second sending unit 230 is configured to send the feedback notification information to the first client once the second bullet screen information obtains the agreement information, and the preset condition is whether the second bullet screen information obtains the agreement information or not. At this time, the feedback notification information may include an information content such as an identifier of a second account agreeing with the second bullet screen information and an agreement degree, so that subsequent communication of the user based on the first account and the second account is facilitated.

From the above, in the embodiment, not only may bullet screen information-based interaction be implemented, but also a bullet screen information-based interaction result may be returned to the account of the corresponding client for the user to view, so that the bullet screen information-based interaction activity of the user is further improved, and the client and the service platform are better utilized.

Furthermore, the forming unit 220 may further be configured to form incentive information according to the agreement information for the second bullet screen information and a preset incentive strategy. Here, the incentive information is configured to form the feedback notification information. Specifically, for example, the forming unit 200 is specifically configured to form the incentive information according to M and the preset incentive strategy.

In a word, the embodiment provides the service platform, which may form the bullet screen information, allow the user to perform bullet screen information-based interaction and return the interaction result to the account of the user, thereby forming a good information interaction stream, better independently utilizing the client and better implementing an information link and information interaction between the client and the service platform.

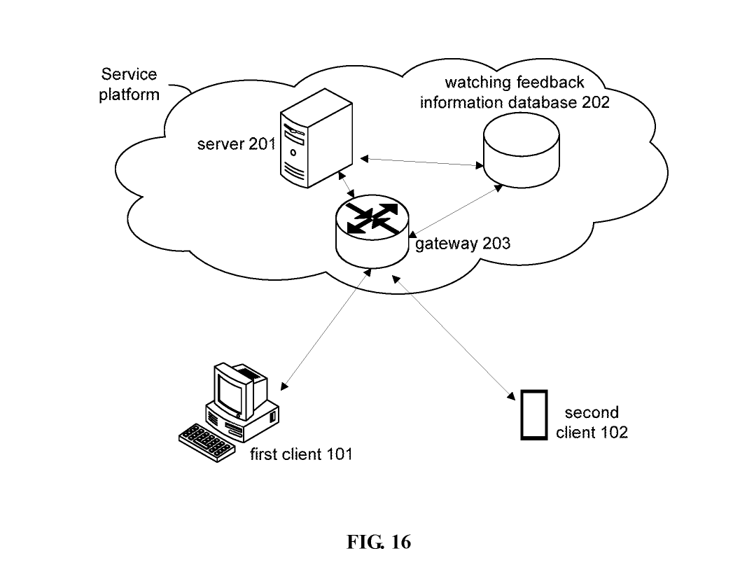

As shown in FIG. 16, the embodiment of the disclosure provides a service platform, which includes a server 201, a watching feedback information database 202 and a gateway 203.

The server 201 may at least be configured to execute bullet screen information processing operation in Step 210 to Step 230. The database 202 stores watching feedback information submitted by each client.

The gateway 203 is an interface configured for information interaction between the service platform and a peripheral device, and is configured to perform processing such as security authentication on a client accessing the service platform and perform security filtering processing on a data packet entering the service platform, so as to avoid data of the service platform being damaged and stolen.

When bullet screen information is formed, the server 201 extracts the users' watching feedback information, formed by a first client and/or a second client on the basis of indications of users, from the database 202, the watching feedback information including various types of information such as assessments of the users, and forms the bullet screen information on the basis of the information. The bullet screen information includes text bullet screen information and/or picture bullet screen information.

The first client 201 and the second client 202 are also shown in FIG. 16; the first client may be a Personal Computer (PC); and the second client may be a mobile phone. The first client and the second client are both clients which may establish connections with the service platform through the Internet. During specific implementation, the clients are not limited to a mobile phone and a PC, and may also be an electronic device with an Internet connecting function such as tablet computers.

The gateway 203 in FIG. 16 refers to a series of gateways connected to the service platform, and for achieving data security and data transmission between the service platform and the client. The gateway usually not only has routing and data packet transfer functions, but also supports security work such as data packet filtering; and therefore, security of the data packet may be ensured.

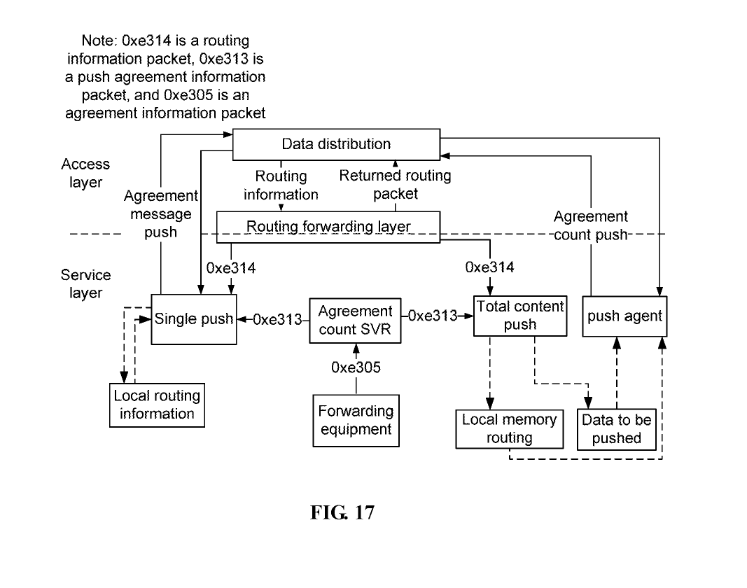

FIG. 17 also provides an architecture of a service platform. The service platform shown in FIG. 17 is divided into a service layer, a routing forwarding layer and an access layer according to data processing logic. The service layer includes a single push logic entity, an agreement count Support Vector Regression (SVR) logic entity, a total content push logic entity and a push agent logic entity; and here, push means pushing. The access layer includes a data distribution logic entity. Here, the routing forwarding layer may correspond to the gateway in FIG. 16. The service layer and the access layer may correspond to the database and server in FIG. 16.

The single push logic entity extracts local routing information; and the local routing information may include a routing data packet formed by a watching feedback information data packet sent by the client and entering the service platform after processing such as routing forwarding.

The single push logic entity finds that the local routing information includes an agreement message, the agreement message mentioned here being one of the agreement information, and then performs agreement message push, thereby triggering the data distribution logic entity of the service layer to form routing information for the routing forwarding layer to send to the client. The routing information includes feedback notification information. After the routing information is successfully forwarded, the routing forwarding layer may form a returned routing packet representing information such as that the routing information has been forwarded; and however, the returned routing packet is not limited to the abovementioned information. Every time when obtaining agreement information of each piece of bullet screen information implemented through the single push logic entity, the service platform may feed back notification feedback information to an account which provides the watching feedback information to form the bullet screen information.

When a piece of bullet screen information obtains an agreement message, the agreement count SVR logic entity may perform counting to determine the current number of agreement messages which have been obtained by the bullet screen information. Specifically, the agreement count SVR logic entity may acquire an agreement information packet from forwarding equipment such as a gateway, and may directly count agreement messages of each piece of bullet screen information according to agreement information in the forwarding equipment.

After counting, the agreement count SVR logic entity may send a push agreement information packet to the single push logic entity and the total content push logic entity respectively. The single push logic entity may execute an information processing flow like that for obtaining of the agreement message from the local routing information; and the processing flow may specifically refer to the corresponding part for obtaining of the agreement message from the local routing information, and will not be repeated.

The total content push logic entity performs processing such as judgment about whether the agreement message meets a preset condition or not according to the information provided by the push agreement information packet of the agreement count SVR logic entity, and at this instant, a display parameter of the bullet screen information is reconfigured, so that the bullet screen information of which the display parameter is reconfigured is resent to the client.

During specific bullet screen information forwarding, the service platform performs local memory routing query, specifically such as operation of querying an Internet Protocol (IP) of the client. Data to be pushed is sent to a push agent, and the push agent forwards the data to the data distribution logic entity for external data sending. Here, the data to be pushed may include the bullet screen information, and the push agent may be understood as a push agent, and may be a unified processing logic entity for bullet screen information-based interaction between the service platform and the client.

The push agent may also send agreement count push to the data distribution logic entity, and this instant, the data distribution logic entity may send feedback notification information to the client through the routing forwarding layer according to the agreement count push. Specifically, after first bullet screen information formed on the basis of watching feedback information of a first account obtains 50 agreement messages, a user may be notified that the watching feedback information sent by a user of the first account obtains agreements of many other users through the feedback notification information. At this instant, a specific content of the feedback notification information may be: your comment has obtained 50 agreements.

At the same time, the push agent mentioned here may further send the agreement count push to the data distribution logic entity to trigger the data distribution logic entity to send sequencing information and the like. Then, the agreement count push may include the number of agreement messages obtained by each piece of bullet screen information and a sequencing result, and the data distribution logic entity sends the sequencing information to each client through the routing forwarding layer for the clients to display in a second data area outside a first output area.

The embodiment of the disclosure further provides a computer storage medium, in which a computer-executable instruction is stored, the computer-executable instruction being configured to execute at least one of the methods shown in FIG. 1 to FIG. 11. The storage medium of the embodiment may be various types of storage media such as a hard disk, a magnetic disk, a compact disc or a flash disk, and is optionally a non-transitory storage medium.

In some embodiments provided by the disclosure, it should be understood that the disclosed equipment and method may be implement in another manner. The equipment embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection implemented through some interfaces, equipment or units, and may also be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve a purpose of the solutions of the embodiment according to a practical requirement.

In addition, each function unit in each embodiment of the disclosure may be integrated into a processing unit, each unit may also exist independently, and two or more than two units may also be integrated into a unit. The integrated unit may be implemented in a hardware form, and may also be implemented in form of combining hardware and a software function unit.

Those skilled in the art should know that: all or part of the steps of the method embodiment may be implemented by related hardware instructed through a program, the program may be stored in a computer-readable storage medium, and the program is executed to execute the steps of the method embodiment; and the storage medium includes: various media capable of storing program codes, such as mobile storage equipment, a Read-Only Memory (ROM), a magnetic disk or a compact disc.

In various embodiments of the disclosure, the bullet screen information overlapped and dynamically displayed over the multimedia information may be formed on the basis of a watching feedback of the user at the same time when the multimedia information is displayed at the client, so that the user may be stimulated to express his/her own opinion; in addition, dynamic display enriches the display form of the bullet screen information, and thus the display effect may be improved; and watching satisfaction of the user may be improved, and software and hardware resource utilization rates and intelligence of the client and the server may be better improved.

The above is only the specific implementation mode of the disclosure and not intended to limit the scope of protection of the disclosure, and any modifications made according to the principle of the disclosure shall fall within the scope of protection of the disclosure.

The above is only the preferred embodiment of the disclosure and not intended to limit the scope of protection of the disclosure, and any modifications made according to the principle of the disclosure shall fall within the scope of protection of the disclosure.

1. A bullet screen information processing method, applied in a first electronic device, the method comprising:
receiving bullet screen information from a server, wherein the bullet screen information is formed on the basis of watching feedback information, and the watching feedback information is formed by at least one of the first electronic device and a second electronic device, in response to an input, during output of first multimedia information, and sent to the server; and
dynamically displaying the bullet screen information in a first output area, in which the first electronic device outputs the first multimedia information, according to a predetermined strategy, wherein the bullet screen information is displayed as being overlaid on the first multimedia information.

2. The method according to claim 1, wherein dynamically displaying the bullet screen information in a first output area, in which the first electronic device outputs the first multimedia information, according to a predetermined strategy comprises:
displaying the bullet screen information; and
controlling the bullet screen information to move according to a predetermined trajectory,
wherein the predetermined trajectory is located in the first output area, in which the first electronic device outputs the first multimedia information.

3. The method according to claim 1, wherein dynamically displaying the bullet screen information in a first output area, in which the first electronic device outputs the first multimedia information, according to a predetermined strategy comprises:
displaying the bullet screen information at a first position at an nth instant; and
hiding the bullet screen information at the first position at an (n+1)th instant,
wherein n is an integer not smaller than 1 and smaller than N, N is a total number of display times of the bullet screen information, and N is an integer not smaller than 2.

4. The method according to claim 1, further comprising:
receiving a first indication during display of the bullet screen information, wherein the first indication represents an agreement with first bullet screen information among the bullet screen information;
displaying reference information representing the agreement with the first bullet screen information, in response to the first indication; and
sending agreement information for the first bullet screen information to the server.

5. The method according to claim 4, wherein a number of pieces of the agreement information obtained by the first bullet screen information within a first specified time is represented by a numerical value m; and
wherein dynamically displaying the bullet screen information comprises:
displaying the first bullet screen information with a first display parameter when m is within a first specified range; or
displaying the first bullet screen information with a second display parameter when m is within a second specified range,
wherein the first specified range is different from the second specified range, and the first display parameter is different from the second display parameter.

6. The method according to claim 5, further comprising:
receiving a second indication during display of the bullet screen information, wherein the second indication represents a disagreement with the first bullet screen information among the bullet screen information;
displaying reference information representing the disagreement with the first bullet screen information, in response to the second indication; and
sending disagreement information for the first bullet screen information to the server.

7. The method according to claim 6, wherein a number of pieces of the disagreement information obtained by the first bullet screen information within the first specified time is represented by a numerical value n, both m and n are 0 or positive integers, s=m−n, and n is an integer; and
wherein dynamically displaying the bullet screen information comprises:
displaying the first bullet screen information with a third display parameter when s is within a third specified range; or
displaying the first bullet screen information with a fourth display parameter when s is within a fourth specified range,
wherein the third specified range is different from the fourth specified range, and the third display parameter is different from the fourth display parameter.

8. The method according to claim 5, wherein the dynamically displayed bullet screen information comprises second bullet screen information formed on the basis of an indication in a first account of the first electronic device;
wherein the method further comprises:
receiving feedback notification information from the server, when agreement information for the second bullet screen information reaches a preset condition; and
displaying the feedback notification information in an interface of the first account in the first electronic device.

9. The method according to claim 6, further comprising:
detecting an interaction position, at which the first indication or the second indication is received, in the first output area; and
statically displaying the first bullet screen information when a distance between the interaction position and the first bullet screen information is within a specified range of a first specified distance,
wherein the specified range is used to receive the first indication or the second indication.

10. The method according to claim 5, further comprising:
receiving sequencing information from the server, wherein the sequencing information is information on all of part of a sequencing result formed by sequencing m or s of the first multimedia information by the server; and
displaying the sequencing information in a second output area, wherein the second output area is positioned near the first output area.

11. A bullet screen information processing method, applied in a server, the method comprising:
receiving watching feedback information from at least one of a first electronic device and a second electronic device, wherein the watching feedback information is formed by the at least one of the first electronic device and the second electronic device, in response to an input, during output of first multimedia information;
forming bullet screen information on the basis of the watching feedback information; and
sending the bullet screen information to the first electronic device which is outputting or intended to output the first multimedia information,
wherein the first electronic device dynamically displays the bullet screen information when outputting the first multimedia information, and the bullet screen information is displayed as being overlaid on the first multimedia information.

12. The method according to claim 11, further comprising:
receiving agreement information from the first electronic device, wherein the agreement information is formed and sent by the first electronic device on the basis of a first indication and the first indication represents an agreement with first bullet screen information among the bullet screen information;
determining a number m of pieces of the agreement information for the first bullet screen information; and
setting a display parameter of the first bullet screen information according to m.

13. The method according to claim 11, wherein setting the display parameter of the first bullet screen information according to m comprises:
configuring the display parameter of the first bullet screen information to be a first display parameter when m is within a first specified range; or
configuring the display parameter of the first bullet screen information to be a second display parameter when m is within a second specified range,
wherein the first specified range is different from the second specified range, and the first display parameter is different from the second display parameter.

14. The method according to claim 13, further comprising:
receiving disagreement information from the first electronic device, wherein the disagreement information is formed and sent by the first electronic device on the basis of a second indication and the second indication represents a disagreement with the first bullet screen information among the bullet screen information; and
determining a number n of pieces of the disagreement information obtained by the first bullet screen information, wherein
setting the display parameter of the first bullet screen information according to m comprises:
setting the display parameter of the first bullet screen information according to m and n.

15. The method according to claim 14, wherein
setting the display parameter of the first bullet screen information according to m and n comprises:
calculating s according to a function s=m−n; and
setting the display parameter of the first bullet screen information to be a third display parameter when s is within a third specified range, or setting the display parameter of the first bullet screen information to be a fourth display parameter when s is within a fourth specified range,
wherein the third specified range is different from the fourth specified range, and the third display parameter is different from the fourth display parameter.

16. The method according to claim 12, wherein the bullet screen information sent to the first electronic device comprises second bullet screen information formed on the basis of an indication of a first account of the first electronic device; and
the method further comprises:
sending feedback notification information to the first electronic device when agreement information of the second bullet screen information reaches a preset condition,
the feedback notification information being configured for the first electronic device to display in an interface of the first account.

17. The method according to claim 15, further comprising:
performing sequencing according to m and s, to form information on a sequencing result; and
sending all or part of the sequencing result information to the first electronic device,
wherein the first electronic device displays the sequencing result information in a second output area, and the second output area is positioned near the first output area.

18. A first electronic device, comprising:
a processor; and
a memory for storing instructions, which, when being executed by the processor, cause the processor to:
receive bullet screen information from a server, wherein the bullet screen information is formed on the basis of watching feedback information, and the watching feedback information is formed by at least one of the first electronic device and a second electronic device, in response to an input, during output of first multimedia information, and sent to the server; and
dynamically display the bullet screen information in a first output area, in which the first electronic device outputs the first multimedia information, according to a predetermined strategy, wherein the bullet screen information is displayed as being overlaid on the first multimedia information.

19. The first electronic device according to claim 18, wherein the instructions, when being executed by the processor, further cause the processor to:
receive a first indication during display of the bullet screen information, wherein the first indication represents an agreement with first bullet screen information among the bullet screen information;
display reference information representing the agreement with the first bullet screen information, in response to the first indication; and
send agreement information for the first bullet screen information to the server.

20. The first electronic device according to claim 19, wherein a number of pieces of the agreement information obtained by the first bullet screen information within a first specified time is represented by a numerical value m; and
wherein the instructions, when being executed by the processor, cause the processor to dynamically display the bullet screen information comprises instructions, when being executed by the processor, cause the processor to:
display the first bullet screen information with a first display parameter when m is within a first specified range, or display the first bullet screen information with a second display parameter when m is within a second specified range,
wherein the first specified range is different from the second specified range, and the first display parameter is different from the second display parameter.
